(19) United States
(12) Patent Application Publication
(10) Pub. No.: US 2004/0209999 A1
(43) Pub. Date: Oct. 21, 2004

(54) Method of manufacturing polypeptides, including T-20 and T-1249, at commercial scale, and polypeptide compositions related thereto

(76) Inventors: James Charles Bohling, Lansdale, PA (US); Biwang Jiang, Warnington, PA (US); Marlin Kenneth Kinzey, Philadelphia, PA (US); John Joseph Maikner, Quakertown, PA (US); James Franklin Tate JR., New Castle, DE (US); William Joseph Zabrodski, Lansdale, PA (US); Witold Andrew Ziarno, Chicago, IL (US)

Correspondence Address: ROHM AND HAAS COMPANY, PATENT DEPARTMENT, 100 INDEPENDENCE MALL WEST, PHILADELPHIA, PA, 19106-2399, US

(21) Appl. No.: 10/786,532

(22) Filed: Feb. 25, 2004

Related U.S. Application Data
(63) Continuation-in-part of application No. 10/636,148, filed on Aug. 7, 2003.
(63) Continuation-in-part of application No. 10/636,186, filed on Aug. 7, 2003.
(63) Continuation-in-part of application No. 10/643,832, filed on Aug. 19, 2003.
(63) Continuation-in-part of application No. 10/638,484, filed on Aug. 12, 2003.
(63) Continuation-in-part of application No. 10/643,361, filed on Aug. 19, 2003.
(60) Provisional application No. 60/404,045, filed on Aug. 16, 2002.
(60) Provisional application No. 60/404,044, filed on Aug. 16, 2002.
(60) Provisional application No. 60/404,472, filed on Aug. 19, 2002.
(60) Provisional application No. 60/404,402, filed on Aug. 19, 2002.
(60) Provisional application No. 60/404,401, filed on Aug. 19, 2002.
(60) Provisional application No. 60/449,895, filed on Feb. 25, 2003.

(51) Int. Cl. C08G 81/00; C08H 1/00

(52) U.S. Cl. 525/54.1

(57) ABSTRACT

The present invention relates to an improved process for making commercial quantities of a polypeptide or fragment thereof, e.g. a T-20 or a T-1249 composition, or a fragment of a T-20 or a T-1249 composition. One variant of a T-20 composition is known as Fuzeon™ enfuvirtide. The improvement includes using a low void space resin, a resin made from a copolymer having less than 5% organic extractables, a resin made using a chloride corrosion resistant filter, resin beads functionalized using a nitro-compound, resins made using jetting techniques, and resins made using seed expansion techniques. In yet other variants, the invention provides a composition made using the processes described herein.

### PRIORITY CLAIMS

This patent applications claims priority to: U.S. Provisional Patent Application serial No. 60/449,895 entitled: METHOD OF MANUFACTURING t-20 AND t-1249 PEPTIDES AT COMMERCIAL SCALE, AND T-20 AND t-1249 COMPOSITIONS RELATED THERETO, filed on Feb. 25, 2003 (DN 1496); U.S. patent application Ser. No. 10/636,148, filed on Aug. 7, 2003, claiming priority to U.S. Provisional Patent Application serial no. 66/404,045, entitled: LOW VOID SPACE RESINS AND METHOD OF PREPARATION, filed on Aug. 16, 2002 (A1406); U.S. patent application Ser. No. 10/636,186, filed on Aug. 7, 2003, claiming priority to U.S. Provisional Patent Application serial No. 60/404,044 entitled: RESIN FOR SOLID PHASE SYNTHESIS, filed on Aug. 16, 2002 (A1407); U.S. patent application Ser. No. 10/643,832, filed on Aug. 19, 2003, claiming priority to U.S. Provisional Patent Application serial No. 60/404,472, entitled: RESIN CLEANING METHOD, filed on Aug. 19, 2002 (A1408); U.S. patent application Ser. No. 10/638,484, entitled: METHOD FOR PREPARING FREE FLOW RESIN filed on Aug. 12, 2003, (A1409A), claiming priority to U.S. Provisional Patent Application serial No. 60/404,402, entitled: METHOD FOR PREPARING FREE FLOW RESIN filed on Aug. 19, 2002 (A1409); and, U.S. patent application Ser. No. 10/643,361, filed on Aug. 19, 2003, claiming priority to U.S. Provisional Patent Application serial No. 60/404,401 entitled: RESIN FUNCTIONALIZATION METHOD, filed on Aug. 19, 2003 (A1410). All of the previously mentioned patent applications are incorporated by reference herein, as if fully set forth.

This invention relates to methods of manufacturing T-20, T-1249, T-20 like peptides, and T-1249 like peptides, and other peptides using functionalized polymeric resins useful as supports in solid phase synthesis.

There exists a significant need in the art for methods of manufacturing the above mentioned peptides at commercial scale. While various techniques are known to work at lab scale, these techniques have a variety of drawbacks when practiced at commercial scale where multi-kilogram quantities of peptides are made. These drawbacks include high cycle times, wasteful use of expensive reagents, poor yields at scale, poor loading efficiencies at scale, use of high volumes of expensive solvents at scale, the need to recouple, and poor purities at scale. Moreover, attempts to reduce cycle times or excesses of expensive reagents have lead to lower product yields and purity, and required increased recoupling. There also have been attempts to recycle conventional CTC resins that are used in peptide synthesis found in the art (Harre et al. Reactive and Functional Polymers 41 (1999) 111-114). However, these attempts failed since there were serious problems with resins of the prior art.

There are several problems with resins of the prior art. First, the resins of the prior art have defects which lead to poor performance. One of these defects is the existence of void spaces in the copolymer or the functionalized beads. Void spaces in the copolymer beads from which functionalized beads are made or the functionalized beads themselves cause weakness in the compolymer beads or functionalized beads which is balanced with additional cross linking in the remainder of the bead. This leads to two different densities of material in the bead. One density is in the void space which is free of linkers and therefore useless for peptide synthesis or peptide building chemistry. The other density is now higher in cross linking which reduces the mass transfer of reagents into and products and byproducts out of the functionalized bead leading to greater reagent useage, wash solvent usage and reduced product yield. When a batch of peptide synthesis resin has a percentage of beads greater than 40% large void spaces (e.g. greater than 6 microns) by count, the batch in use will have excess swelling and poor performance. The excess results in bead compressibility leading to poor draining and poor mechanical stability. This was addressed conventionally by adding additional cross linker to the copolymer to the next batch of resin after the first batch was discarded to achieve the desired swelling level. However, adding additional cross linker increases the cross link density and lowers the mass transport through the gel phase or no void section of the functionalized bead, leading to poor performance in peptide synthesis methods.

A second problem with the resins of the art involves the existence of organic extractables. Even when unfunctionalized perfect beads are formed, when they are washed with swelling solvents extractables (e.g. monomers and oligomers) are removed leading to the formation of undesirable void spaces. When one has unwashed copolymer beads, as soon as the beads are functionalized, the are washed. This washing creates undesirable void spaces since extractables are removed. There exists a need for a resin that is used in a method of making a peptide that has been made from a copolymer that has extremely low levels of organic extractables.

Another problem with resins of the prior art involves undesirable leacheables and resin discolorization. Undesirable leachables in the peptide manufacturing process result from the resin manufacturing process. By way of example, when resins are manufactured they pass through a filter. Stainless steel filters that are used for resin manufacturing processes are not chloride resistant. As such, chloride from the resin manufacturing process corrodes stainless steel reactors. These corrosion products to make their way into the resin products which are then used to synthesize polypeptides for human and animal treatment of diseases or conditions. There exists a need in the art for a method of making peptides that uses a resin that does not have undesirable corrosion products therein.

Yet a further drawback of the art is that resins in the art used in methods for making peptides are not free flowing. Resins that are not free flowing are harder to initially load with amino acid. Resins that are not free flowing also are not easily mechanically transferred from storage vessels to reactors. There exists a need in the art for a method of making peptides that uses a resin that has free flowing properties.

Yet a further drawback of the art involves inhomogeneity within a batch or functionalized resin beads. The batch is only as good as the weakest beads. This is because all peptide build reactions must be run to completion. If they are not run to completion, peptide fragments of different lengths or amino acid sequence, contaminate the final desired product of a specific length. Where intra-batch inhomogeneity exists, one group of beads may require higher reagent usages or higher cycle times to reach the desired final peptide purity and length, while another group of beads requires less. If not all beads within a batch are homogeneous and a predeterimined amount of reagent is used, bad fragments will be obtained from one group of bad beads, while good fragments will be obtained from a second group of beads resulting in a contaminated final mixture.

It is an object of the invention to solve these and other problems facing the art, and to provide a method by which commercially useful quantities of polypeptides, e.g. T-20, and T-1249, can be manfuctured.

### SUMMARY OF THE INVENTION

In one variant, the present invention relates to an improved process for making a T-20 or a T-1249 composition, or a fragment of a T-20 or a T-1249 composition. The improvement includes using a low void space resin optionally loaded with an amino acid or amino acid derivative to create one or more T-20 or T-1249 fragments.

In another aspect, the process uses about 1.5 equivalents of the amino acid per equivalent of growing peptide chain.

In yet a further aspect, the process includes recycling the low void space resin.

In yet another aspect the invention provides for preparing a T-20 or T-1249 fragment having greater than about 10 or about 15 amino acids, in which the process is free of or substantially free of recouples and uses substantially lower quantities of reagents.

In yet another variant, the invention provides a T-20 or T-1249 composition, in which one or more fragments of T-20 or T-1249 are made by the processes described herein.

These and other objects of the invention are described in the remaining portions of the specification, including but not limited to the detailed description of the invention.

### DETAILED DESCRIPTION OF THE INVENTION

The present invention relates to an improved process for making a T-20 or a T-1249 composition, a fragment of a T-20 or a T-1249 composition, or other peptide or polypeptide compositions. The improvement includes using a resin having the characteristics described below. The resin is optionally loaded with an amino acid or amino acid derivative to create one or more T-20 or T-1249; fragments.

An exemplary “amino acid” that can be used with the resins described in the present invention, and loaded on the resin as described herein, is a compound represented by NH.sub.2—CHR—COOH, wherein R is H, an aliphatic group, a substituted aliphatic group, an aromatic group or a substituted aromatic group. A “naturally-occurring amino acid” is found in nature. Examples include alanine, valine, leucine, isoleucine, aspartic acid, glutamic acid, serine, threonine, glutamine, asparagine, arginine, lysine, ornithine, proline, hydroxyproline, phenylalanine, tyrosine, tryptophan, cysteine, methionine and histidine. R is the side-chain of the amino acid. Examples of naturally occurring amino acid side-chains include methyl (alanine), isopropyl (valine), sec-butyl (isoleucine), —CH.sub.2CH(—CH).sub.2 (leucine), benzyl (phenylalanine), p-hydroxybenzyl (tyrosine), —CH.sub.20H (serine), CHOHCH.sub.3 (threonine), —CH.sub.2-3-indoyl (tryptophan), —CH.sub.2COOH (aspartic acid), CH.sub.2CH.sub.2COOH (glutamic acid), —CH.sub.2C(O)NH.sub.2 (asparagine), —CH.sub.2CH.sub.2C(O)NH.sub.2 (glutamine), —CH.sub.SSH, (cysteine), —CH.sub.2CH.sub.2SCH.sub.3 (methionine), —(CH.sub.2).sub.4NH.sub.2 (lysine), —(CH.sub.2).sub. 3NH.sub.2 (omithine), —[(CH).sub.2].sub.4NHC(.-dbd.NH)NH.sub.2 (arginine) and —CH.sub.2-3-imidazoyl (histidine). The side-chains of alanine, valine, leucine and isoleucine are aliphatic, i.e., contain only carbon and hydrogen, and are each referred to herein as “the aliphatic side chain of a naturally occurring amino acid.”

The side chains of other naturally-occurring amino acids that can be used in the present invention include a heteroatom-containing functional group, e.g., an alcohol (serine, tyrosine, hydroxyproline and threonine), an amine (lysine, omithine, histidine and arginine), a thiol (cysteine) or a carboxylic acid (aspartic acid and glutamic acid). When the heteroatom-containing functional group is modified to include a protecting group, the side-chain is referred to as the “protected side-chain” of an amino acid.

The selection of a suitable protecting group depends upon the functional group being protected, the conditions to which the protecting group is being exposed and to other functional groups which may be present in the molecule. Suitable protecting groups for the functional groups discussed above are described in Greene and Wuts, “Protective Groups in Organic Synthesis”, John Wiley & Sons (1991), the entire teachings of which are incorporated into this application by reference as if fully set forth herein. The skilled artisan can select, using no more than routine experimentation, suitable protecting groups for use in the disclosed synthesis, including protecting groups other than those described below, as well as conditions for applying and removing the protecting groups.

Examples of suitable alcohol protecting groups include benzyl, allyl, trimethylsilyl, tert-butyldimethylsilyl, acetate, and the like. Examples of suitable amino protecting groups include benzyloxycarbonyl, tert-butoxycarbonyl, tert-butyl, benzyl and fluorenylmethyloxycarbonyl (Fmoc). Tert-butoxycarbonyl is an amine protecting group. Examples of suitable carboxylic acid protecting groups include tert-butyl, trityl, methyl, methoxylmethyl, trimethylsilyl, benzyloxymethyl, tert-butyldimethylsilyl and the like. Tert-butyl is a carboxylic acid protecting group. Examples of suitable thiol protecting groups include S-benzyl, S-tert-butyl, S-acetyl, S-methoxymethyl, S-trity land the like.

Lysine, aspartate and threonine are examples of amino acid side-chains that are preferably protected in one variant of the invention. Aliphatic groups include straight chained, branched C.sub.1-C.sub.8, or cyclic C.sub.3-C.sub.8 hydrocarbons which are completely saturated or which contain one or more units of unsaturation. In one example, an aliphatic group is a C1-C4 alkyl group. Aromatic groups include carbocyclic aromatic groups such as phenyl, 1-naphthyl, 2-naphthyl, 1-anthracyl and 2-anthracyl, and heterocyclic aromatic groups such as N-imidazolyl, 2-imidazole, 2-thienyl, 3-thienyl, 2-furanyl, 3-furanyl, 2-pyridyl, 3-pyridyl, 4-pyridyl, 2-pyrimidy, 4-pyrimidyl, 2-pyranyl, 3-pyranyl, 3-pyrazolyl, 4-pyrazolyl, 5-pyrazolyl, 2-pyrazinyl, 2-thiazole, 4-thiazole, 5-thiazole, 2-oxazolyl, 4-oxazolyl and 5-oxazolyl.

Aromatic groups also include fused polycyclic aromatic ring systems in which a carbocyclic aromatic ring or heteroaryl ring is fused to one or more other heteroaryl rings. Examples include 2-benzothienyl, 3-benzothienyl, 2-benzofuranyl, 3-benzofuranyl, 2-indolyl, 3-indolyl, 2-quinolinyl, 3-quinolinyl, 2-benzothiazole, 2-benzooxazole, 2-benzimidazole, 2-quinolinyl, 3-quinolinyl, 1-isoquinolinyl, 3-quinolinyl, 1-isoindolyl, 3-isoindolyl, and acridintyl.

Suitable substituents for an aryl group and aliphatic group are those which are compatible with the disclosed reactions, i.e., do not significantly reduce the yield of the reactions and do not cause a significant amount of side reactions. Suitable substituents generally include aliphatic groups, substituted aliphatic groups, aryl groups, halogens, halogenated alkyl groups (e.g., trihalomethyl), nitro, nitrile, —CONHR, —CON(R).sub.2, —OR, —SR, —S(O)R, —S(O).sub.2R, wherein each R is independently an aliphatic group, or an aryl group. Although certain functional groups may not be compatible with one or more of the disclosed reactions, these functional groups may be present in a protected form. The protecting group can then be removed to regenerate the original functional group. Skilled artisan will be able to select, using no more than routine experimentation, protecting groups which are compatible with the disclosed reactions.

A peptide mimetic, or component thereof, can also be used in the present invention, loaded onto a resin as described herein, or created by the process described herein. A peptide mimetic is a compound which has sufficient structural similarity to a peptide so that the desirable properties of the peptide are retained by the mimetic. For example, peptide mimetics used as protease inhibitors for treating HIV infection, are disclosed in Tung, et al., WO 94/05639, Vazquez, et al., WO 94/04491, Vazquez, et al., WO 94/10134 and Vaquez, et al., WO 94/04493. The entire relevant teachings of these publications are incorporated herein by reference. To be useful as a drug, a peptide mimetic should retain the biological activity of a peptide, but also have one or more properties which are improved compared with the peptide which is being mimicked. For example, some peptide mimetics are resistant to hydrolysis or to degradation in vivo. One strategy for preparing a peptide mimetic is to replace one or more amino acid residues in a peptide with a group which is structurally related to the amino acid residue(s) being replaced and which can form peptide bonds. The development of new amino acid derivatives which can be used to replace amino acid residues in peptides will advance the development of new peptide mimetic drugs.

Exemplary peptide mimetics are described in U.S. patent application Ser. No. 20020188135 by Gabriel, Richard L. et al. filed on Dec. 12, 2002 entitled, “Amino acid derivatives and methods of making the same.” This patent application is incorporated by reference herein as if fully set forth. Also useful in the present invention are physiologically acceptable salts of these compounds. Salts of compounds containing an amine or other basic group can be obtained, for example, by reacting with a suitable organic or inorganic acid, such as hydrogen chloride, hydrogen bromide, acetic acid, perchloric acid and the like. Compounds with a quaternary ammonium group also contain a counteranion such as chloride, bromide, iodide, acetate, perchlorate and the like. Salts of compounds containing a carboxylic acid or other acidic functional group can be prepared by reacting with a suitable base, for example, a hydroxide base. Salts of acidic functional groups contain a countercation such as sodium, potassium and the like.

The present invention is also useful in the creation and manufacture of therapeutic agents and biologically active substances that have one or more peptides, peptide derivatives, or peptide mimetics as building blocks or constituents thereof. The therapeutic agent that can be manufactured or created using the invention can vary widely with the purpose for the composition. The agent(s) may be described as a single entity or a combination of entities. The delivery system is designed to be used with therapeutic agents having high water-solubility as well as with those having low water-solubility to produce a delivery system that has controlled release rates. The terms “therapeutic agent” and “biologically active substance” include without limitation, medicaments; vitamins; mineral supplements; substances used for the treatment, prevention, diagnosis

The following example illustrates how to functionalize copolymer beads. This process is described in more detail in U.S. Provisional Patent Application, by Bohling et al., filed Aug. 16, 2002, Serial No. 60/404,044, entitled: RESIN FOR SOLID PHASE SYNTHESIS (DN A01407), incorporated by reference herein as if fully set forth as mentioned previously. The resin is optionally loaded with an amino acid or amino acid derivative, to create one or more T-20 or T-1249 fragments.

By way of example, the present invention uses a crosslinked polymer bead which, when: (i) functionalized with a 2-chlorotrityl chloride group; (ii) coupled with Leu to 0.65 mmol/g; and (iii) coupled with Glu(t-Bu); allows coupling of FMOC-Lys(BOC)—OH at an amount of 1.5 equivalents in the presence of 1.5 equivalents of HOBT, 1.5 equivalents of DIEA and 1.5 equivalents of HBTU, to be completed, as determined by the Kaiser test, in no more than 35 minutes.

The present invention uses a functionalized crosslinked polymer bead produced by a method comprising steps of (a) swelling the bead in a first solvent or solvent mixture to a volume from 200% to 310% of its volume when dry; and (b) contacting the bead with a functionalizing reagent (e.g. Friedel Crafts catalyst coordinated with nitro-benzene) in a second solvent or solvent mixture capable of swelling the bead to a volume from 200% to 310% of its volume when dry.

The present invention uses a functionalized crosslinked polymer bead produced by contacting the bead at 100% to 200% of its volume when dry with a functionalizing reagent in a solvent or solvent mixture capable of swelling the bead to a volume from 200% to 400% of its volume when dry. The functionalized resin may swell to as much as 700% by the end of the reaction.

Percentages are weight percentages, unless specified otherwise. As used herein the term “(meth)acrylic” refers to acrylic or methacrylic. The term “vinyl monomer” refers to a monomer suitable for addition polymerization and containing a single polymerizable carbon-carbon double bond. The term “styrene polymer” indicates a copolymer polymerized from a vinyl monomer or mixture of vinyl monomers containing at least 50 weight percent, based on the total monomer weight, of styrene monomer, along with at least one crosslinker. Preferably a styrene polymer is made from a mixture of monomers that is at least 75% styrene, more preferably at least 90% styrene, and most preferably from a mixture of monomers that consists essentially of styrene and at least one vinylaromatic crosslinker. The polymeric bead used as a starting material in this invention contains monomer residues from at least one monomer having one copolymerizable carbon-carbon double bond and at least one crosslinker. The monomer residues derived from the crosslinker are from 0.5 mole percent to 1.5 mole percent based on the total of all monomer residues. Preferably the amount of crosslinker is from 0.7 to 1.3 mole percent, more preferably from 0.7 to 1.2 mole percent, and most preferably from 0.8 to 1.2 mole percent.

A polymeric bead used as a starting material in the present invention preferably is a spherical copolymer bead. It optionally has a particle diameter no greater than 200 microns (em), preferably no greater than 170 μm, more preferably no greater than 150 μm, more preferably no greater than 125 μm, and most preferably no greater than 100 μm. Preferably, the bead has no void spaces having a diameter greater than 3 μm, more preferably no void spaces having a diameter greater than 2 μm, and most preferably no void spaces having a diameter greater than 1 μm. Typically, void spaces are readily apparent upon surface examination of the bead by a technique such as light microscopy.

The polymeric bead used as a starting material in the present invention preferably is produced by a suspension polymerization. A typical bead preparation, for example, may include preparation of a continuous aqueous phase solution containing typical suspension aids, for example, dispersants, protective colloids and buffers. Preferably, to aid in production of relatively small beads, a surfactant is included in the aqueous solution, preferably a sodium alkyl sulfate surfactant, and vigorous agitation is maintained during the polymerization process. The aqueous solution is combined with a monomer mixture containing at least one vinyl monomer, at least one crosslinker and at least one free-radical initiator. Preferably, the total initiator level is from 0.25 mole percent to 2 mole %, based on the total monomer charge, preferably from 0.4 mole percent to 1.5 mole percent, more preferably from 0.4 mole percent to 1 mole percent, and most preferably from 0.5 mole percent to 0.8 mole percent. The mixture of monomers is then polymerized at elevated temperature. Preferably, the polymerization is continued for a time sufficient to reduce the unreacted vinyl monomer content to less than 1% of the starting amount. The resulting bead is then isolated by conventional means, such as dewatering, washing with an aprotic organic solvent, and drying.

Crosslinkers are monomers having 2 or more copolymerizable carbon-carbon double bonds per molecule, such as: divinylbenzene, divinyltoluene, divinylxylene, trivinylbenzene, trivinylcyclohexane, divinylnaphthalene, trivinylnaphthalene, diethyleneglycol divinylether, ethyleneglycol dimethacrylate, polyethyleneglycol dimethacrylate, triethyleneglycol dimethacrylate, trimethylolpropane trimethacrylate, allyl methacrylate, 1,5-hexadiene, 1,7-octadiene or 1,4-bis(4-vinylphenoxy)butane; it is understood that any of the various positional isomers of each of the aforementioned crosslinkers is suitable. Preferred crosslinkers are divinylbenzene, divinyltoluene, trivinylbenzene or 1,4-bis(4-vinylphenoxy)butane. The most preferred crosslinker is divinylbenzene.

Suitable monounsaturated vinylaromatic monomers that may be used in the preparation of the bead used as a starting material in the present invention include, for example, styrene, α-methylstyrene, (C₁-C₄)alkyl-substituted styrenes and vinylnaphthalene; preferably one or more monounsaturated vinylaromatic monomer is selected from the group consisting of styrene and (C₁-C₄)alkyl-substituted styrenes. Included among the suitable (C₁-C₄)alkyl-substituted styrenes are, for example, ethylvinylbenzenes, vinyltoluenes, diethylstyrenes, ethylmethylstyrenes, dimethylstyrenes and isomers of vinylbenzyl chloride; it is understood that any of the various positional isomers of each of the aforementioned vinylaromatic monomers is suitable.

Optionally, non-aromatic vinyl monomers, such as aliphatic unsaturated monomers, for example, acrylonitrile, glycidyl methacrylate, (meth)acrylic acids and amides or C₁-C₆ alkyl esters of (meth)acrylic acids may also be used in addition to the vinylaromatic monomer. When used, the non-aromatic vinyl monomers typically comprise as polymerized units, from zero to 20%, preferably from zero to 10%, and more preferably from zero to 5% of the copolymer, based on the total monomer weight used to form the copolymer.

Preferred vinyl monomers are the vinylaromatic monomers; more preferably styrene, isomers of vinylbenzyl chloride, and α-methylstyrene. The most preferred vinyl monomer is styrene.

Polymerization initiators useful in the present invention include monomer-soluble initiators such as peroxides, hydroperoxides, peroxyesters and related initiators; for example benzoyl peroxide, tert-butyl hydroperoxide, cumene peroxide, tetralin peroxide, acetyl peroxide, caproyl peroxide, tert-butyl peroctoate (also known as tert-butylperoxy-2-ethylhexanoate), tert-amyl peroctoate, tert-butyl perbenzoate, tertbutyl diperphthalate, dicyclohexyl peroxydicarbonate, di(4-tert-butylcyclohexyl)peroxydicarbonate and methyl ethyl ketone peroxide. Also useful are azo initiators such as azodiisobutyronitrile, azodiisobutyramide, 2,2′-azo-bis(2,4-dimethylvaleronitrile), azo-bis(α-methyl-butyronitrile) and dimethyl-, diethyl- or dibutyl azo-bis(methylvalerate). Preferred peroxide initiators are diacyl peroxides, such as benzoyl peroxide, and peroxyesters, such as tert-butyl peroctoate and tert-butyl perbenzoate.

Dispersants and suspending agents useful in the present invention are nonionic surfactants having a hydroxyalkylcellulose backbone, a hydrophobic alkyl side chain containing from 1 to 24 carbon atoms, and an average of from 1 to 8, preferably from 1 to 5, ethylene oxide groups substituting each repeating unit of the hydroxyalkyl-cellulose backbone, the alkyl side chains being present at a level of 0.1 to 10 alkyl groups per 100 repeating units in the hydroxyalkylcellulose backbone. The alkyl group in the hydroxyalkylcellulose may contain from 1 to 24 carbons, and may be linear, branched or cyclic. More preferred is a hydroxyethylcellulose containing from 0.1 to 10 (C₁₆)alkyl side chains per 100 anhydroglucose units and from about 2.5 to 4 ethylene oxide groups substituting each anhydroglucose unit. Typical use levels of dispersants are from about 0.01 to about 4%, based upon the total aqueous-phase weight. One example of a useful dispersant in Culminal™ MHEC 8000, commercially available from Hercules of Wilmington, Del.

Optionally, the preparation of the beads may include an enzyme treatment to cleanse the polymer surface of residues of dispersants and suspending agents used during the polymerization. The enzyme treatment typically involves contacting the polymeric phase with the enzymatic material (selected from one or more of cellulose-decomposing enzyme and proteolytic enzyme) during polymerization, following polymerization or after isolation of the polymer. Japanese Patent Applications No. 61-141704 and No. 57-98504 may be consulted for further general and specific details on the use of enzymes during the preparation of polymer resins. Suitable enzymes include, for example, cellulose-decomposing enzymes, such as β-1,4-glucan-4-glucano-hydrase, β-1,4-glucan-4-glucanhydrolase, β-1,4-glucan-4-glucohydrase and β-1,4-glucan-4-cellobiohydrase, for cellulose-based dispersant systems; and proteolytic enzymes, such as urokinase, elastase and enterokinase, for gelatin-based dispersant systems. Typically, the amount of enzyme used relative to the polymer is from 2 to 35%, preferably from 5 to 25% and more preferably from 10 to 20%, based on total weight of polymer.

In the method of the present invention, the swelling of the crosslinked polymeric beads is controlled so that the bead is partially swelled during functionalization. Without wishing to be bound by theory, the effect of functionalizing a partially swollen bead is to limit the location of the attached functional groups to a region relatively close to the surface of the bead. Preferably, when the functionalization occurs, the bead is swollen to at least 200% of its volume when dry, more preferably at least 210%, more preferably at least 220%, more preferably at least 230%, and most preferably at least 240%. Preferably, the bead is swollen to no more than 310% of its volume when dry, more preferably no more than 300%, more preferably no more than 290%, and most preferably no more than 280%. There are different means for accomplishing the desired degree of swelling during functionalization.

In one embodiment of the invention, a bead which is not pre-swollen (i.e., at 100% of its volume when dry), or which is pre-swollen to no more than 200% of its volume when dry, is contacted with a functionalizing reagent in a solvent or solvent mixture capable of swelling the bead to at least 200% of its volume when dry, more preferably at least 210%, more preferably at least 220%, more preferably at least 230%, and most preferably at least 240%. Preferably, the solvent or solvent mixture is capable of swelling the bead to no more than 400% of its volume when dry, more preferably no more than 370%, more preferably no more than 340%, and most preferably no more than 320%. Preferably, the bead is pre-swollen to no more than 150%, more preferably no more than 100%, more preferably no more than 80%, more preferably no more than 60%, and most preferably no more than 40%. In one embodiment, the bead is used in its dry state without pre-swelling. The resin may swell to greater than 700% by the completion of the reaction.

In another embodiment of the invention, the bead is pre-swollen in a solvent or solvent mixture which swells the bead to at least 200% of its volume when dry, more preferably at least 210%, more preferably at least 220%, more preferably at least 230%, and most preferably at least 240%. Preferably, the bead is swollen to no more than 310% of its volume when dry, more preferably no more than 300%, more preferably no more than 290%, and most preferably no more than 280%. After pre-swelling, the bead is contacted with a functionalizing reagent in a solvent or solvent mixture capable of swelling the bead within the aforementioned limits. Most preferably, the solvents or solvent mixtures used for pre-swelling and functionalization are the same.

A functionalizing reagent is one which covalently attaches a functional group to the polymer comprising the bead. Further elaboration of the functional group may be necessary to maximize the utility of the bead as a support for solid phase synthesis. However, the initial attachment of the functional group determines the region of the bead which is functionalized and thus tends to control the ability of the bead to react with substrates for solid phase synthesis and to allow recovery of the synthetic product. For styrene polymers, the functionalization typically is a Friedel-Crafts substitution on the aromatic ring, preferably an acylation, bromination, or halomethylation. Subsequent elaboration of the initial functional group typically is done. For example, acylation by aroyl halides often is followed by addition of an aryl lithium to the carbonyl group of the product to produce a triaryl carbinol functional group, which then is halogenated to produce a trityl halide functional group. In one preferred embodiment of the invention, 2-chlorobenzoyl chloride, followed by phenyllithium, and then thionyl chloride, produces a 2-chlorotrityl chloride functional group. Bromination typically is followed by treatment with an alkyl lithium reagent and reaction of the aryl lithium product with a variety of reagents to produce different functional groups. Halomethyl groups also may react with a variety of reagents to produce different functional groups.

Exemplary other linkers that are used in the invention include a Wang linker, a sasrin linker, a trityl based linker, a halogenated Wang linker, and a rink linker. It is appreciated that other linkers known in the art other than these mentioned can also be used in the invention.

Solvents capable of partially swelling the bead include, for example, C₁-C₆ nitroalkanes, and mixtures of relatively non-swelling solvents such as alkanes with nitrobenzene or chlorinated hydrocarbons. For functionalization using Friedel-Crafts chemistry, C₃-C₆ nitroalkanes, and mixtures of relatively non-swelling solvents such as alkanes with nitrobenzene are preferred.

The functionalized beads described herein are useful, for example, in solid-phase organic synthesis, solid-phase peptide synthesis, and scavenging of reaction byproducts. Typically, coupling reactions between the functionalized beads and reagents in solution occur faster than with conventional functionalized polymer beads. For example, when a 2-chlorotrityl-chloride functional group on a functionalized bead described herein reacts with a given concentration of a protected amino acid reagent in the presence of typical coupling reagents used in peptide synthesis, the reaction typically is complete in the same time or a shorter time than that observed for a conventional functionalized bead, as demonstrated below in Example 8 and Table 4. Coupling efficiency for reaction of the functionalized bead of this invention with a protected amino acid residue is greater than that of conventional beads, as demonstrated below by weight gain of the beads in Example 6 and Table 2, and by HPLC measurements of cleaved amino acid in Example 7 and Table 3.

Typical loading of amino acid, with or without typical protecting groups well known in peptide synthesis, onto the functionalized beads of this invention is from 0.2 meq/g to 1.0 meq/g, based on the weight of the unloaded beads. In one embodiment of the invention, preferably, at least 0.25 meq/g is loaded, more preferably at least 0.3 meq/g, more preferably at least 0.5 meq/g, and most preferably at least 0.6 meq/g. Preferably, the loading is no more than 0.9 meq/g, more preferably no more than 0.8 meq/g, and most preferably no more than 0.7 meq/g. In another embodiment of the invention, preferably, at least 0.6 meq/g is loaded, more preferably at least 0.7 meq/g, more preferably at least 0.8 meq/g, and most preferably at least 0.9 meq/g. Preferably, the loading is no more than 1.2 meq/g, more preferably no more than 1.1 meq/g, and most preferably no more than 1.0 meq/g.

### COMPARATIVE EXAMPLE

### Internal and Functionalization of Pre-Swelled Crosslinked Polystyrene Beads

A 1L round bottom flask fitted with an overhead stirrer, N₂ inlet fitted with a pressure relief upstream, and a thermocouple was purged with a light positive pressure of nitrogen (sweep against open stopper while making additions). Nitrobenzene (400 mL) was charged and held at room temperature. A polystyrene resin (40 g, 0.379 mol) was charged against the nitrogen sweep and stirred for ½ hour. Chlorobenzoyl chloride (24.89 g, 0.142 mol) was charged to the flask and stirred for 15 minutes. Inside a glove bag filled with nitrogen, aluminum chloride (18.96 g, 0.142 mol) was weighed into a sealed bottle, which then was charged into the reaction flask against the nitrogen sweep. The contents of the flask were heated to 30° C. and held for 4 hours. The reaction mixture was poured into a buchner filter funnel, and the reaction flask washed with a small amount of nitrobenzene to complete transfer. The filter was drained to resin level, and nitrobenzene (280 mL, 1 bed volume) was added, and the filter drained again. Tetrahydrofuran (“THF”) (2 bed volumes) was added on top of resin bed, which was allowed to drain. The color was removed as the THF replaced the nitrobenzene. One bed volume of 4:1 THF:H₂O was added and the resin was re-suspended, then the filter was drained to the resin level and one bed volume of THF was added on top of the resin. The filter was allowed to drain to the resin level. One bed volume of THF was added and the resin was re-suspended, then the filter was drained to the resin level and one bed volume of THF was added on top of the resin. The filter was allowed to drain to the resin level. One bed volume of methanol was added on top of resin. The filter was allowed to drain to the resin level. One bed volume of methanol was added and the resin was re-suspended, then the filter was drained to the resin level and one bed volume of methanol was added on top of the resin. The filter was allowed to drain to the resin level. Minimal vacuum was applied to remove excess solvent. The resin was dried in a 35° C. vacuum oven to a constant weight.

### EXAMPLE

### Functionalization of a Crosslinked Polystyrene Bead by Functionalization of Unswelled Beads

A 1 L round bottom flask fitted with an overhead stirrer, N₂ inlet fitted with a pressure relief upstream, and a thermocouple was purged with a light positive pressure of nitrogen (sweep against open stopper while making additions). Nitrobenzene (400 mL) was charged and held at room temperature. Inside a glove bag filled with nitrogen, aluminum chloride (18.96 g, 0.142 mol) was weighed into a sealed bottle, which then was charged into the reaction flask against the nitrogen sweep. After the aluminum chloride was dissolved (ca. 5 minutes), chlorobenzoyl chloride (24.89 g, 0.142 mol) was charged to the flask and stirred for 5 minutes. A polystyrene resin (40 g, 0.379 mol) was charged against the nitrogen sweep and stirred for ½ hour. The contents of the flask were heated to 30° C. and held for an additional 3.5 hours. The reaction mixture was poured into a buchner filter funnel, and the reaction flask washed with a small amount of nitrobenzene to complete transfer. The filter was drained to resin level, and nitrobenzene (280 mL, 1 bed volume) was added, and the filter drained again. Tetrahydrofuran (“THF”) (2 bed volumes) was added on top of resin bed, which was allowed to drain. The color was removed as the THF replaced the nitrobenzene. One bed volume of 4:1 THF:H₂O was added and the resin was re-suspended, then the filter was drained to the resin level and one bed volume of THF was added on top of the resin. The filter was allowed to drain to the resin level. One bed volume of THF was added and the resin was re-suspended, then the filter was drained to the resin level and one bed volume of THF was added on top of the resin. The filter was allowed to drain to the resin level. One bed volume of methanol was added on top of the resin. The filter was allowed to drain to the resin level. One bed volume of methanol was added and the resin was re-suspended, then the filter was drained to the resin level and one bed volume of methanol was added on top of the resin. The filter was allowed to drain to the resin level. Minimal vacuum was applied to remove excess solvent. The resin was dried in a 35° C. vacuum oven to a constant weight.

### EXAMPLE

### Functionalization of Crosslinked Polystyrene Beads by Selection of Functionalization Solvent

A 1 L round bottom flask fitted with an overhead stirrer, N₂ inlet fitted with a pressure relief upstream, and a thermocouple is purged with a light positive pressure of nitrogen (sweep against open stopper while making additions). Nitroethane (400 mL) is charged and held at room temperature. A polystyrene resin (40 g, 0.379 mol) is charged against the nitrogen sweep and stirred for ½ hour. Chlorobenzoyl chloride (24.89 g, 0.142 mol) is charged to the flask and stirred for 15 minutes. Inside a glove bag filled with nitrogen, aluminum chloride (18.96 g, 0.142 mol) is weighed into a sealed bottle, which then is charged into the reaction flask against the nitrogen sweep. The contents of the flask are heated to 30° C. and held for an additional 3.75 hours. The reaction mixture is poured into a buchner filter funnel, and the reaction flask washed with a small amount of nitrobenzene to complete transfer. The filter is drained to resin level, and nitrobenzene (280 mL, 1 bed volume) is added, and the filter drained again. Tetrahydrofuran (“THF”) (2 bed volumes) is added on top of the resin bed, which is allowed to drain. The color is removed as the THF replaces the nitrobenzene. One bed volume of 4:1 THF:H₂O is added and the resin is re-suspended, then the filter is drained to the resin level and one bed volume of THF is added on top of the resin. The filter is allowed to drain to the resin level. One bed volume of THF is added and the resin is re-suspended, then the filter is drained to the resin level and one bed volume of THF is added on top of the resin. The filter is allowed to drain to the resin level. One bed volume of methanol is added on top of resin. The filter is allowed to drain to the resin level. One bed volume of methanol is added and the resin is re-suspended, then the filter is drained to the resin level and one bed volume of methanol is added on top of the resin. The filter is allowed to drain to the resin level. Minimal vacuum is applied to remove excess solvent. The resin is dried in a 35° C. vacuum oven to a constant weight.

### EXAMPLE

### Functionalization of Crosslinked Polystyrene Beads by Use of a Mixed Functionalization Solvent

A 1 L round bottom flask fitted with an overhead stirrer, N₂ inlet fitted with a pressure relief upstream, and a thermocouple is purged with a light positive pressure of nitrogen (sweep against open stopper while making additions). Nitrobenzene (60 mL) and Heptane (440 mL) are charged and held at room temperature. A polystyrene resin (40 g, 0.379 mol) is charged against the nitrogen sweep and stirred for ½ hour. Chlorobenzoyl chloride (24.89 g, 0.142 mol) is charged to the flask and stirred for 15 minutes. Inside a glove bag filled with nitrogen, aluminum chloride (18.96 g, 0.142 mol) is weighed into a sealed bottle, which then is charged into the reaction flask against the nitrogen sweep. The contents of the flask are heated to 30° C. and held for 4 hours. The reaction mixture is poured into a buchner filter funnel, and the reaction flask washed with a small amount of nitrobenzene to complete transfer. The filter is drained to resin level, and nitrobenzene (280 mL, 1 bed volume) is added, and the filter drained again. Tetrahydrofuran (“THF”) (2 bed volumes) is added on top of resin bed, which is allowed to drain. The color is removed as the THF replaces the nitrobenzene. One bed volume of 4:1 THF:H₂O is added and the resin is re-suspended, then the filter is drained to the resin level and one bed volume of THF is added on top of the resin. The filter is allowed to drain to the resin level. One bed volume of THF is added and the resin is re-suspended, then the filter is drained to the resin level and one bed volume of THF is added on top of the resin. The filter is allowed to drain to the resin level. One bed volume of methanol is added on top of resin. The filter is allowed to drain to the resin level. One bed volume of methanol is added and the resin is re-suspended, then the filter is drained to the resin level and one bed volume of methanol is added on top of the resin. The filter is allowed to drain to the resin level. Minimal vacuum is applied to remove excess solvent. The resin is dried in a 35° C. vacuum oven to a constant weight.

### EXAMPLE

### General Procedure for Final Functionalization of Crosslinked Beads

In an oven dried four neck round bottom flask (equipped with a stirrer, a condenser w/nitrogen bubbler, a temperature controller, and a septum) was taken the THF and the dried bead resulting from any of the previous Examples (10:1, volume:weight). The mixture was stirred for 15 minutes. Phenyl lithium (1.25 equivalents) was added drop wise over 10 minutes. The temperature was kept <30° C. by an ice/water bath. The reaction mixture was then stirred at ambient temperature for 1 hour. Quenching was accomplished by drop wise addition of 10% aqueous HCl, keeping the reaction temperature below 30° C. The mixture was stirred for 1 hour. The contents are then transferred to a sinter glass funnel and drained to bed height. The resin was then re-suspended in 1 bed volume of 4:1 THF/10% HCl(v/v) and allowed to drain to bed height slowly. The resin was re-suspended with 1 bed volume of 4:1 THF/water and allowed to drain. The bed was then re-suspended and drained 3 times with 1 bed volume of THF, followed by re-suspending/draining 3 times with 1 bed volume of methanol. A final rinse through of the bed is done with 1 bed volume of methanol. Vacuum was applied to remove excess solvent and then the beads were dried in a 35° C. vacuum oven.

In an oven dried four neck round bottom flask (equipped with a stirrer, a temperature controller, a condenser w/nitrogen bubbler, and a stopper) was added the methylene chloride (or optionally toluene) and the dried bead from the previous step (10:1). Added thionyl chloride (5 equivalents) drop-wise followed by N,N-dimethylformamide (5 mole % based on thionyl chloride). The mixture was warmed to reflux (37° C.) for 4 hours. After cooling to ambient temperature, the reaction mixture was transferred to a nitrogen purged sintered glass funnel and drained to bed height. The bed was then re-suspended and drained twice with 1 bed volume of methylene chloride (or optionally toluene). It was then further washed by re-suspending/draining three times with 1 bed volume of anhydrous hexane. Purged through the bed with nitrogen to remove excess solvent and then placed the beads in a vacuum oven at ambient temperature. The trityl chloride functionalized bead resulting from this preparation is useful, for example, in solid phase peptide synthesis.

### EXAMPLE

### Swelling of Crosslinked Polystyrene Beads in Various Solvents

Crosslinked polystyrene beads made using 1% and approximately 1.5% divinylbenzene as a crosslinker, and having a volume when dry of 1.65 mL/g were swelled in solvents, with the results presented below in Table 1 in mL/g. Solvent ratios are volume:volume.

TABLE 1

| | 1.5% | |
|---|---|---|
| Solvent | crosslinker | 1% crosslinker |
| nitromethane | 2.5 | N/A |
| nitropropane | 3.7 | 4.05 |
| 1:1, nitropropane:heptane | 3.6 | 4.3 |
| 1:2, nitropropane:heptane | 3.5 | 3.7 |
| 1:3, nitropropane:heptane | 3.3 | 3.55 |
| nitrobenzene | 4.0 | 5.3 |
| 1:1, nitrobenzene:heptane | 4.6 | 5.6 |
| 1:2, nitrobenzene:heptane | 4.5 | 5.05 |
| 1:3, nitrobenzene:heptane | 4.2 | 4.3 |
| methanol | 1.7 | N/A |
| heptane | 1.9 | N/A |

### EXAMPLE

### Loading of Functionalized Crosslinked Beads with Fmoc-L-Leucine

A 2-chlorotrityl chloride resin produced according to Example 4 was loaded with Fmoc-L-Leucine, treated with methanol to remove residual reactive chloride and dried. The weight gain was used to quantify loading. The resin was assumed to have a capacity of 1.3 mmol/g. The relatively minor molecular weight effect of the methoxy end-capping was ignored. The resin was cleaved with 1% TFA/DCM, and the solution was analyzed by HPLC to determine the cleaved yield (recovery) of amino acid.

Each sample of the resin (1.0000+/−0.05 g) was weighed into a 60 mL glass synthesizer vessel with a side port and a removable disk. The resin in the synthesizer was pre-swelled with dichloromethane (DCM). The DCM was drained and to each synthesizer was added a solution of Fmoc-L-Leu-OH and diisopropylethylamine (DIEA) in 10 ml DCM. Slow nitrogen agitation was started. For the five resins of this invention, the quantities, in grams, of Fmoc-L-Leu-OH were (3.181, 0.597, 0.358, 0.299, 0.239) and of DIEA, in mL, were (1.568, 0.294, 0.177, 0.147, 0.118) per sample, respectively. Each mixture was allowed to react at ambient temperature for two hours, then the solution was drained and any remaining trityl chloride end groups were capped by treatment for at least 30 minutes with DIEA (1 mL) in methanol (9 mL). Each sample of resin was washed with 5×10 mL portions of DCM and transferred to a tared 30 mL fritted glass funnel, then washed with another 2×10 mL portions of DCM. Each loaded resin was then de-swelled with 4×10 mL portions of isopropanol (IPA) and partially dried by pulling air through the filter cake with vacuum, then drying the filter and resin overnight in a vacuum oven at 30° C. The filter and resin were then re-weighed and the difference in mass calculated. Mass of Leu=Final wt-(filter tare+1.000 g resin). Loading efficiency=(weight of Leu on resin/weight of Leu charged)*100. The weight gain and loading efficiency are reported in Table 2 for five resins of this invention (RH1—RH5) and for three competitive resins processed according to the procedures given in this Example (CM1-CM3). The cleaved yield for the same resins is reported in Table 3. The amount of amino acid (AA) is in mmol, the weight gain (gain) in mmol, and the loading efficiency (eff.) in %.

The five resins of the present invention have higher loading efficiency than any of the competitive resins in Table 2. This higher load efficiency is in the range of an about 7.5 to about 28% improvement over the conventional resins in Table 2.

TABLE 2
Weight Gain and Loading Efficiency Comparison

| | amount of AA | | | | | | | |
|---|---|---|---|---|---|---|---|---|
| | 0.61 | 0.68 | 0.73 | 0.84-0.85 | 0.97 | 1.01 | 1.05 | 1.26 |
| gain, | | 0.54 | | 0.81 | | 0.97 | | |
| RH1 | | | | | | | | |
| gain, | | 0.31 | | 0.52 | | 0.79 | | |
| RH2 | | | | | | | | |
| gain, | | 0.49 | | 0.60 | | 0.82 | | |
| RH3 | | | | | | | | |
| gain, | | 0.66 | | 0.75 | | 0.98 | | |
| RH4 | | | | | | | | |
| gain, | | 0.63 | | 0.82 | | 0.86 | | |
| RH5 | | | | | | | | |
| avg. | | 0.53 | | 0.70 | | 0.88 | | |
| gain, | | | | | | | | |
| RH1- | | | | | | | | |
| RH5 | | | | | | | | |
| gain, | | 0.34 | | 0.53 | | 0.81 | | |
| CM1 | | | | | | | | |
| gain, | 0.26 | | 0.32 | | 0.73 | | | |
| CM2 | | | | | | | | |
| gain, | | | | 0.46 | | | 0.80 | 0.88 |
| CM3 | | | | | | | | |
| eff., | | 80.5 | | 95.8 | | 96.1 | | |
| RH1 | | | | | | | | |
| eff., | | 45.5 | | 61.4 | | 77.7 | | |
| RH2 | | | | | | | | |
| eff., | | 72.5 | | 70.9 | | 80.8 | | |
| RH3 | | | | | | | | |
| eff., | | 97.7 | | 88.5 | | 97.1 | | |
| RH4 | | | | | | | | |
| eff., | | 93.2 | | 96.8 | | 84.9 | | |
| RH5 | | | | | | | | |
| avg. eff., | | 77.9 | | 82.7 | | 87.3 | | |
| RH1- | | | | | | | | |
| RH5 | | | | | | | | |
| eff., CM1 | | 49.9 | | 62.4 | | 79.8 | | |
| eff., CM2 | 42.5 | | 44.4 | | 75.2 | | | |
| eff., CM3 | | | | 55.2 | | | 76.4 | 70.0 |

CM2 is a resin available from Novabiochem under the name 2-Chlorotritylchloride Resin (100-200 mesh), 1% DVB; Cat. No. 01-64-0114
CM3 is a resin available from Polymer Labs under the name Cl-Trt-Cl Resin (75-150 micron), 1% DVB, Part No. 3473-2799

### EXAMPLE

### Cleavage of Fmoc-L-Leucine from Functionalized Beads

Each sample of the resin (1.0000+/−0.05 g) was weighed into a fritted glass filter. The resin was pre-swelled by agitating the funnel with DCM (10 mL), the DCM was drained, and the resin washed 3×10 mL DCM. The resin bound Fmoc-L-Leu-OH was cleaved by agitating with 9×10 ml of 1% TFA/DCM (v:v), draining into a 100 mL volumetric flask, and filling to the mark with DCM. The contents of the flask were agitated to provide the sample solution to be analyzed by HPLC.

The sample solution was injected into a liquid chromatographic system capable of generating a binary solvent gradient, and equipped with a sample injector, a variable wavelength detector and electronic data acquisition system (HP 1090 with ChemStation™ software). Column: YMC ODS-AQ, S-3, 120 A, 50 mm×4 mm ID column Catalog # AQ12S030504WT

Conditions:

Flow rate: 1.5 mls/min

Program: 40% B, hold 10.0 min

40% B to 90% B over 2.5 minutes, hold 1 minute 90% B over 2 minutes hold 10 minutes until next injection.

Injection vol.: 10 uL

Detection: photodiode array detector 265 nm bandwidth 16 nm, ref 350 nm, bw 100 nm, or variable wavelength UV Detector at 265 nm.

Standard Preparation:

Approximately 5.0 mg of the Fmoc-L-Leu-OH reference standard were weighed into a 25 mL volumetric flask. The standard was dissolved in about 10 mL of acetonitrile (often requires sonication). Water (12 mL) was added, the contents were mixed, and the flask was allowed to come to ambient temperature. The flask was filled to the mark with water and the contents were mixed.

Sample Preparation:

The sample solution (5.00 mL) was measured into a 25 mL volumetric flask, and reduced to dryness at ambient temperature with a gentle nitrogen stream. The residue was dissolved in 10 mL of acetonitrile (often requires sonication). Water (12 mL) was added, the contents were mixed well and the flask allowed to come to ambient temperature. The flask was filled to the mark with water and agitated.

A blank (water:acetonitrile 3:2) was injected and the gradient program started.

Concomitantly, the sample and standard were injected.

The loading of the Fmoc-L-Leu on the resin was calculated by:

Fmoc-L-Leu in sample flask=Area sample/Area standard×Wt of standard×Purity of standard/25.0 mL×25.0 mL/5.0 mL

Resin Loading (mmol/g of dry resin)=Amt of Fmoc L-Leu-OH in sample flask/Wt of loaded resin g×353.4 [353.4 is the molecular weight of the Fmoc-L-Leu-OH]

Results for the amount of cleaved Fmoc L-Leu-OH in mmol (“AA”) for each amount of amino acid used to load the resins initially for the RH1 to RH5 and CM1 materials are reported in Table 3. Load efficiencies are also reported, assuming that the cleaved amount equals the amount bound to the resin.

TABLE 3
Cleaved Amino Acid Yield Comparison

| | | | |
|---|---|---|---|
| amount | 0.68 | 0.85 | 1.01 |
| of AA | | | |
| AA, RH1 | 0.56 | 0.85 | 0.99 |
| AA, RH2 | 0.31 | 0.51 | 0.82 |
| AA, RH3 | 0.50 | 0.61 | 0.84 |
| AA, RH4 | 0.63 | 0.72 | 0.99 |
| AA, RH5 | 0.64 | 0.87 | 0.88 |
| avg. AA, | 0.53 | 0.71 | 0.90 |
| RH1-RH5 | | | |
| AA, CM1 | 0.33 | 0.60 | 0.85 |
| eff., RH1 | 82.4 | 100.0 | 98.0 |
| eff., RH2 | 45.6 | 60.0 | 81.2 |
| eff., RH3 | 73.5 | 71.8 | 83.2 |
| eff., RH4 | 92.6 | 84.7 | 98.0 |
| eff., RH5 | 94.1 | 102.4 | 87.1 |
| avg. eff., | 77.6 | 83.8 | 89.5 |
| RH1-RH5 | | | |
| eff., CM1 | 48.5 | 70.6 | 84.2 |

The cleaved amino acid yield for the resins of the present invention was 5-20% greater than the conventional resins. It is appreciated that the cleaved peptide fragment yield will be higher than when the same fragments are cleaved from the competitive resin.

### EXAMPLE

### Peptide Build Kinetic Efficiency Comparison

This Example describes the preparation of a nine-peptide fragment of the peptide known as T-20, described in U.S. Pat. No. 6,015,881, Table 1, as Peptide No. 11, containing amino acids 17-26. The kinetics of the reaction are followed by sampling resin periodically during the coupling and running a Kaiser test to determine the presence of any unreacted primary amine. The resin according to Example 4 is compared with two competitive resins, one from Novabiochem, and the other from Polymer Labs.

A 2-chlorotrityl chloride resin produced according to Example 4 was loaded with Fmoc-L-Leucine, treated with methanol to remove residual reactive chloride and dried. A sample of the resin (1.0 g) was weighed into a 60 mL glass synthesizer vessel with a side port and a removable disk. DCM (10 mL) was charged to the vessel and agitated with nitrogen for 30 minutes, then drained. The leucine derivatized resin is then deprotected by charging 10 mL of a 25% solution of piperidine in N-methylpyrrolidone (NMP), agitating for 10 minutes, draining and repeating once. The deprotection residue was removed by washing with 7×10 mL volumes of NMP. The activated ester of next amino acid in sequence was prepared by dissolving 1.5 eq of amino acid (Fmoc-glu(t-Bu)-OH was the first added in this sequence, see table for charges and formula weights), 1.5 eq of 1-hydroxybenzotriazole (HOBT) (0.149 g) and 1.5 eq of DIEA (0.126 g) into 7.5 mL of NMP at room temperature. The solution was then chilled and 1.5 eq of O-benzotriazol-1-yl-N,N,N′,N′,-tetramethyluronium hexafluorophosphate (HBTU) (0.370 g) was added and stirred for 30 minutes. DCM (2.5 mL) was then charged to the solution and allowed to stand for 30 minutes. The activated amino acid solution was then charged to the drained resin and agitated with nitrogen. Samples were obtained and analyzed (Kaiser test) each 15 minutes and the results recorded. Upon completion of the reaction the resin was drained and washed with NMP (3×10 mL). This process is then repeated from the deprotection with piperidine for the rest of the amino acids in the sequence. (Glu(tBu), Lys(Boc), Asn(trt), Glu(tBu), Gln(trt), Glu(tBu), leu, leu,).

The results for the three resins are presented below in Table 4, with times expressed as the time to a negative Kaiser Test.

TABLE 4
Peptide Synthesis Efficiency Comparison

| | | |
|---|---|---|
| | | Polymer Nova Biochem |
| Amino Acid | R + H | Labs |

| | | | |
|---|---|---|---|
| 1 | 45 | 60 | 60 |
| 2 | 30 | 60 | 60 |
| 3 | 60 | 60 | 60 |
| 4 | 30 | 45 | 45 |
| 5 | 60 | 60 | 60 |
| 6 | 30 | 45 | 45 |
| 7 | 30 | 45 | 30 |
| 8 | 30 | 45 | 30 |
| 9 | 30 | 45 | 45 |
| Total Cycle | 345 | 465 | 435 |
| Time | | | |

The time required for complete reaction with each amino acid added to the growing chain on the bead of this invention is the same or less than for the conventional beads.

APPENDIX 1
AA usage

| | | g |
|---|---|---|
| Monomer | fwt | required |
| FMOC Glu (t-Bu) | 425.48 | 0.415 |
| FMOC Lys (Boc) | 468.55 | 0.457 |
| FMOC Asn (trt) | 596.68 | 0.582 |
| FMOC Glu (t-Bu) | 425.48 | 0.415 |
| FMOC Gln (trt) | 610.71 | 0.595 |
| FMOC Glu (t-Bu) | 425.48 | 0.415 |
| FMOC Leu | 353.42 | 0.345 |
| FMOC Leu | 353.42 | 0.345 |
| FMOC Glu (t-Bu) | 425.48 | 0.415 |
| HOBT | 153.15 | 0.149 |
| DIEA | 129.25 | 0.126 |
| HBTU | 379.25 | 0.370 |

| | | | | |
|---|---|---|---|---|
| LeuCT-resin (g) = | 1.00 | Total NMP | 1035.5 | mL |
| Loading Level (mmol/g) = | 0.65 | Total DCM | 72.5 | mL |
| Number of samples = | 1.00 | Total | 32 | mL |
| | | Piperdine | | |
| Total resin(g) = | 1.00 | Total HOBT | 1.344 | g |
| Total mmol = | 0.65 | Total DIEA | 1.134 | g |
| Eq. of Monomer Charge = | 1.50 | Total HBTU | 3.328 | g |
| Coupling cycles per step = | 1.00 | | | |
| Monomer usage/Cycle | 0.975 | | | |
| (mmol) = | | | | |
| AA Added 9 | | | | |

APPENDIX 2
Solvent usage

| | each sample | Total | Total |
|---|---|---|---|
| SetUp | each cycle | each cycle | complete |
| Resin | 1.00 g | 1.00 g | 1.00 g |
| Swell | | | |
| DCM | 10 mL | 10 | 10 |
| Stir for 15 min | | | |
| Deprotect | | | |
| 20% Piperidine in | 10 mL | 10 | |
| NMP | | | |
| Cycles | 2 | | |
| Total | 20 mL | 20 | 160 |
| Stir for 10 min/cycle | | | |
| Wash 1 | | | |
| NMP | 10 mL | 10 | |
| Cycles | 7 | | |
| Total | 70 mL | 70 | 560 |
| Coupling | | | |
| MonomersSee AA | | | |
| Sheet | | | |
| NMP | 7.5 mL | 7.5 | 67.5 |
| DCM | 2.5 mL | 2.5 | 22.5 |
| Wash 2 | | | |
| NMP | 10 | 10 | |
| Cycles | 3 | | |
| Total | 30 | 30 | 240 |
| Final Wash | | | |
| NMP | 10 | 10 | |
| Cycles | 4 | | |
| Total NMP | 40 | 40 | 40 |
| DCM | 10 | 10 | |
| Cycles | 4 | | |
| Total DCM | 40 | 40 | 40 |
| Total NMP | 1035.5 mL | | |
| Total DCM | 72.5 mL | | |
| Total Piperdine | 32 mL | | |

It is appreciated that improved accessibility leads to more efficient coupling and washing resulting in decreased solvent usage at commercial scale. By way of example a 10% reduction in NMP usage will provide a 15500 L reduction per 100 kg of peptide product.

Appendix 3 Kaiser Test Method

The Kaiser test is a test for primary amines and is employed to determine the extent of peptide coupling. A sample of loaded resin (3-20 mg) is placed into a culture tube and evaporated to dryness. The resin is then washed 3 times with ethanol. Five drops of reagent 1 (KCN in pyridine) is added along with 3 drops of reagent 2 (ninhydrin solution) and 3 drops of reagent 3 (phenol in Ethanol). The solution is diluted to 0.5 mL then heated to 75° C. for 10 minutes. After 10 minutes the tubes are chilled in a cold water bath. The beads are then observed in front of a white background. A negative test is indicated if the solution is yellow and the beads are transparent. A blue or violet color indicates the presence of free amines and incomplete coupling.

In yet another variant, the invention provides an improved process for making a T-20 or a T-1249 composition, or a fragment of a T-20 or a T-1249 composition using a low void space resin optionally loaded with an amino acid or amino acid derivative to create one or more T-20 or T-1249 fragments.

The present invention uses, by way of non-limiting example, a crosslinked polymeric bead comprising a polymer having from 0.5 mole percent to 2 mole percent crosslinker; wherein the bead has a diameter no greater than 200 μm, no void spaces having a diameter greater than about 5 μm, and less than 5 weight percent of organic extractables.

The resins of the present invention can be prepared by the following exemplary method. The method includes the steps of (a) preparing a suspension polymerization mixture in a vessel; the mixture comprising: (i) a monomer mixture comprising at least one vinyl monomer and at least one crosslinker; and (ii) from 0.25 mole percent to 1.5 mole percent of at least one free radical initiator; (b) removing oxygen from the vessel by introducing an inert gas for a time sufficient to produce an atmosphere in the vessel containing no more than 5 percent oxygen; (c) allowing the monomer mixture to polymerize; and (d) washing the bead with an aprotic organic solvent. Of course, it is appreciated that other methods can also be used to obtain the resins used in the present invention having the qualities of being low void space resins.

As used herein the term “(meth)acrylic” refers to acrylic or methacrylic. The term “vinyl monomer” refers to a monomer suitable for addition polymerization and containing a single polymerizable carbon-carbon double bond. The term “styrene polymer” indicates a copolymer polymerized from a vinyl monomer or mixture of vinyl monomers containing at least 50 weight percent, based on the total monomer weight, of styrene monomer, along with at least one crosslinker. Preferably a styrene polymer is made from a mixture of monomers that is at least 75% styrene, more preferably at least 90% styrene, and most preferably from a mixture of monomers that consists essentially of styrene and at least one vinylaromatic crosslinker. The lightly crosslinked polymeric bead of this invention contains monomer residues from at least one monomer having one copolymerizable carbon-carbon double bond and at least one crosslinker. The monomer residues derived from the crosslinker are from 0.5 mole percent to 2 mole percent based on the total of all monomer reisdues.

Preferably, organic extractables are removed from the beads of the present invention by treatment with a non-protic organic solvent, preferably one that is not an aliphatic hydrocarbon, for example, halogenated hydrocarbons, cyclic ethers, ketones and aromatic hydrocarbons. Particularly preferred solvents are dichloromethane, dichloroethane, chloroform, chlorobenzene, o-dichlorobenzene, tetrahydrofuran, dioxane, acetonitrile, acetone, xylene and toluene. Preferably, the beads of the present invention contain less than 4 weight percent of organic extractables, more preferably less than 3 weight percent, more preferably less than 2 weight percent, more preferably less than 1 weight percent, and most preferably the beads are substantially free of organic extractables. In one embodiment of the invention, the beads contain less than 3 weight percent of unreacted monomer, more preferably less than 2 weight percent, more preferably less than 1 weight percent, and most preferably the beads are substantially free of unreacted monomer. Typically, the beads contain low levels of extractables and unreacted monomer even prior to washing with an aprotic organic solvent. When the polymer is a styrene polymer crosslinked with divinylbenzene (“DVB”), unreacted monomer may comprise unpolymerized ethylvinylbenzene (“EVB”), a common impurity in commercial divinylbenzene, and possibly also unreacted styrene. Commercial divinylbenzene typically has a purity from 55% to 80%, with the remainder largely consisting of ethylvinylbenzene. Preferably, divinylbenzene with a purity of at least 60% is used, more preferably at least 70%, more preferably at least 75%, and most preferably at least 80%.

A polymeric bead used in the present invention is, in one example, a spherical copolymer bead having a particle diameter no greater than 200 microns (μm), preferably no greater than 170 μm, more preferably no greater than 150 μm, more preferably no greater than 125 μm, and most preferably no greater than 100 μm. Preferably, the bead has no void spaces having a diameter greater than 3 μm, more preferably no void spaces having a diameter greater than 2 μm, and most preferably no void spaces having a diameter greater than 1 μm. Typically, void spaces are readily apparent upon surface examination of the bead by a technique such as light microscopy.

The polymeric bead used in the present invention preferably is produced by a suspension polymerization. A typical bead preparation, for example, may include preparation of a continuous aqueous phase solution containing typical suspension aids, for example, dispersants, protective colloids and buffers. Preferably, to aid in production of the relatively small beads of the present invention, a surfactant is included in the aqueous solution, preferably a sodium alkyl sulfate surfactant, and vigorous agitation is maintained during the polymerization process. The aqueous solution is combined with a monomer mixture containing at least one vinyl monomer, at least one crosslinker and at least one free-radical initiator. Preferably, the total initiator level is from 0.25 mole percent to 1.5 mole %, based on the total monomer charge, preferably from 0.4 mole percent to 1 mole percent, more preferably from 0.4 mole percent to 0.8 mole percent, and most preferably from 0.5 mole percent to 0.7 mole percent. The mixture is purged of most of the oxygen by introducing an inert gas until the oxygen level in the atmosphere in the reaction vessel (head space) is less than 5%, preferably less than 3%, more preferably less than 2%, and most preferably less than 1%. Preferably, the inert gas is introduced into the aqueous solution and the monomer mixture, as well as the head space. The mixture of monomers is then polymerized at elevated temperature. Preferably, the polymerization is continued for a time sufficient to reduce the unreacted vinyl monomer content to less than 1% of the starting amount. The resulting bead is then isolated by conventional means, such as dewatering, washing with an aprotic organic solvent, and drying.

Where one or more of the monomers contains a phenolic polymerization inhibitor, the aqueous phase of the suspension polymerization mixture is maintained at a pH from 9 to 11.5 to extract the phenolic inhibitor from the monomer phase as much as possible. Preferably, the pH of the aqueous phase is from 9.5 to 11.

Crosslinkers are monomers having 2 or more copolymerizable carbon-carbon double bonds per molecule, such as: divinylbenzene, divinyltoluene, divinylxylene, trivinylbenzene, trivinylcyclohexane, divinylnaphthalene, trivinylnaphthalene, diethyleneglycol divinylether, ethyleneglycol dimethacrylate, polyethyleneglycol dimethacrylate triethyleneglycol dimethacrylate, trimethylolpropane trimethacrylate, allyl methacrylate, 1,5-hexadiene, 1,7-octadiene or 1,4-bis(4-vinylphenoxy)butane; it is understood that any of the various positional isomers of each of the aforementioned crosslinkers is suitable. Preferred crosslinkers are divinylbenzene, divinyltoluene, trivinylbenzene or 1,4-bis(4-vinylphenoxy)butane. The most preferred crosslinker is divinylbenzene.

Suitable monounsaturated vinylaromatic monomers that may be used in the preparation of the bead used in the present invention include, for example, styrene, α-methylstyrene, (C₁-C₄)alkyl-substituted styrenes and vinylnaphthalene; preferably one or more monounsaturated vinylaromatic monomer is selected from the group consisting of styrene and (C₁-C₄)alkyl-substituted styrenes. Included among the suitable (C₁-C₄)alkyl-substituted styrenes are, for example, ethylvinylbenzenes, vinyltoluenes, diethylstyrenes, ethylmethylstyrenes, dimethylstyrenes and isomers of vinylbenzyl chloride; it is understood that any of the various positional isomers of each of the aforementioned vinylaromatic monomers is suitable.

Optionally, non-aromatic vinyl monomers, such as aliphatic unsaturated monomers, for example, acrylonitrile, glycidyl methacrylate, (meth)acrylic acids and amides or C₁-C₆ alkyl esters of (meth)acrylic acids may also be used in addition to the vinylaromatic monomer. When used, the non-aromatic vinyl monomers typically comprise as polymerized units, from zero to 20%, preferably from zero to 10%, and more preferably from zero to 5% of the copolymer, based on the total monomer weight used to form the copolymer.

Preferred vinyl monomers are the vinylaromatic monomers; more preferably styrene, isomers of vinylbenzyl chloride, and α-methylstyrene. The most preferred vinyl monomer is styrene.

Polymerization initiators useful preparing the beads used in the present invention include monomer-soluble initiators such as peroxides, hydroperoxides, peroxyesters and related initiators; for example benzoyl peroxide, tert-butyl hydroperoxide, cumene peroxide, tetralin peroxide, acetyl peroxide, caproyl peroxide, tertbutyl peroctoate (also known as tert-butylperoxy-2-ethylhexanoate), tert-amyl peroctoate, tertbutyl perbenzoate, tert-butyl diperphthalate, dicyclohexyl peroxydicarbonate, di(4-tert-butylcyclohexyl)peroxydicarbonate and methyl ethyl ketone peroxide. Also useful are azo initiators such as azodiisobutyronitrile, azodiisobutyramide, 2,2′-azo-bis(2,4-dimethylvaleronitrile), azo-bis(α-methyl-butyronitrile) and dimethyl-, diethyl- or dibutyl azo-his(methylvalerate). Preferred peroxide initiators are diacyl peroxides, such as benzoyl peroxide, and peroxyesters, such as tertbutyl peroctoate and tert-butyl perbenzoate.

Dispersants and suspending agents useful in the present invention are nonionic surfactants having a hydroxyalkylcellulose backbone, a hydrophobic alkyl side chain containing from 1 to 24 carbon atoms, and an average of from 1 to 8, preferably from 1 to 5, ethylene oxide groups substituting each repeating unit of the hydroxyalkyl-cellulose backbone, the alkyl side chains being present at a level of 0.1 to 10 alkyl groups per 100 repeating units in the hydroxyalkylcellulose backbone. The alkyl group in the hydroxyalkylcellulose may contain from 1 to 24 carbons, and may be linear, branched or cyclic. More preferred is a hydroxyethylcellulose containing from 0.1 to 10 (C₁₆)alkyl side chains per 100 anhydroglucose units and from about 2.5 to 4 ethylene oxide groups substituting each anhydroglucose unit. Typical use levels of dispersants are from about 0.01 to about 4%, based upon the total aqueous-phase weight.

Optionally, the preparation of the beads may include an enzyme treatment to cleanse the polymer surface of residues of dispersants and suspending agents used during the polymerization. The enzyme treatment typically involves contacting the polymeric phase with the enzymatic material (selected from one or more of cellulose-decomposing enzyme and proteolytic enzyme) during polymerization, following polymerization or after isolation of the polymer. Japanese Patent Applications No. 61-141704 and No. 57-98504 may be consulted for further general and specific details on the use of enzymes during the preparation of polymer resins. Suitable enzymes include, for example, cellulose-decomposing enzymes, such as β-1,4-glucan-4-glucano-hydrase, β-1,4-glucan-4-glucanhydrolase, β-1,4-glucan-4-glucohydrase and? β-1,4-glucan-4-cellobiohydrase, for cellulose-based dispersant systems; and proteolytic enzymes, such as urokinase, elastase and enterokinase, for gelatin-based dispersant systems. Typically, the amount of enzyme used relative to the polymer is from 2 to 35%, preferably from 5 to 25% and more preferably from 10 to 20%, based on total weight of polymer.

In a preferred embodiment, the beads used in the present invention are lightly crosslinked polymeric bead having no void spaces having a diameter greater than 5 μm; the beads are produced by a method comprising steps of: (a) preparing a suspension polymerization mixture in a vessel; said mixture comprising: (i) a monomer mixture comprising at least one vinyl monomer and at least one crosslinker; and (ii) from 0.25 mole percent to 1.5 mole percent of at least one free radical initiator; (b) removing oxygen from the suspension polymerization mixture and the vessel by introducing an inert gas for a time sufficient to produce an atmosphere in the vessel containing no more than 5 percent oxygen; (c) allowing the monomer mixture to polymerize; and (d) washing the bead with an aprotic organic solvent. Preferably, the bead made according to this process has no void spaces with a diameter greater than 4 μm, more preferably no void spaces with a diameter greater than 3 μm, and most preferably no void spaces with a diameter greater than 1 μm. Preferably, the bead has less than 5% of organic extractables, more preferably less than 3%, more preferably less than 2%, and most preferably less than 1%. Preferably, the bead has less than 4% of residual monomer, more preferably less than 3%, more preferably less than 2%, and most preferably less than 1%.

Without wishing to be bound by theory, it is believed that the process of this invention facilitates more complete polymerization than previously known processes, and thus reduces the amount of organic extractable materials present in the bead, and therefore also reduces the formation of void spaces in the beads after washing with aprotic organic solvents.

In one variant, of the invention copolymer is made using the following process: 662 ml of deionized (“DI”) water was charged to a round bottom flask, stirred at 150 rpm and heated to 80° C. under a nitrogen sweep. When the temperature was reached, the flask was charged slowly with 3.31 g of methylhydroxyethylcellulose (e.g. Culminal™ MHEC 8000 from Hercules Chemical Company (Wilmington, Del.). The temperature was maintained for 60 minutes at 80° C., after which the aqueous solution was cooled to 25° C. to 30° C. The following were charged to the flask: 2.4 g 50% NaOH, 2.5 g boric acid, 0.036 g sodium lauryl sulfate and 0.1 g sodium nitrite. The contents of the flask were stirred for 30 minutes.

The monomer mixture was prepared in a separate beaker by charging the following: 6.55 g 80% DVB (divinylbenzene), 440.0 g styrene, 5.8 g Trigonox 21 (t-butyl peroxy-2-ethylhexanoate, obtained from Noury Chemical Corp., Burt, N.Y.). The mixture was transferred to an addition funnel and sparged with nitrogen for 40 minutes.

The agitator speed was adjusted to 275 rpm in the round bottom flask containing the aqueous phase before charging the monomer mixture to the flask. The agitator was stopped and the monomer mixture was charged to the aqueous solution, taking care to position the addition funnel so as not to introduce air to the monomer solution. After charging the monomer mixture, agitation was resumed and continued for 30 minutes at 25° C. The temperature was increased to 84° C. over 1 hour and maintained there for 12 hours.

The batch was cooled to 45° C., and the pH adjusted to 5.0 with HCl (37%). Cellulase™ 4000 (19.05 g) (cellulase enzyme, obtained from Valley Research, South Bend, Ind.) was charged to the batch, and stirred for 2 hours at 45° C. After the 2 hour hold a second charge of Cellulase™4000 was added and the temperature maintained for 2 hours at 45° C. At the end of the hold period the batch was cooled to room temperature, removed from the flask and washed with DI water.

Typically, the yield of polymeric beads is approximately 90%, with some polymer lost due to agitator fouling or dispersion in the aqueous phase. The level of residual monomer varies with several parameters, including the thoroughness of the inertion with nitrogen, purity of DVB, and initiator level, as illustrated in the Table. Inertion of reactants or reaction vessel was not performed, except as noted.

TABLE

| Initiator¹, | DVB | Residual | |
|---|---|---|---|
| weight % | purity, % | Styrene, % | Comments |
| 1.29 | 80 | 3.6 | monomer, aqueous not inerted |
| 1.29 | 80 | 0.6 | full inertion as described in |
| | | | procedure given above |
| 1.29 | 55 | 8.6 | added to achieve same DVB level |
| 1.29 | 80 | 3.7 | |
| 1.29 | 55 | 2.5 | full inertion |
| 1.29 | 80 | 3.6 | |
| 2.30 | 80 | 8.5 | |

¹t-butyl peroxy-2-ethylhexanoate.

The polymer is, optionally washed according to the following procedure. A 4.4 cm diameter, 50 cm long column is loaded with 100 mL of the copolymer. The copolymer is washed with 8 bed volumes of aprotic organic solvent at a flow rate of 0.5 bed volumes/hour in a down flow direction. The bed is washed with 4 bed volumes of methanol or water at a flow rate of 0.5 bed volumes/hour in a down flow direction. The bed is dried in a stream of nitrogen and then dried under vacuum at 45° C. for 18 hours.

In one variant of the invention, the resin used comprises a crosslinked polymeric bead having a polymer having from 0.5 mole percent to 2 mole percent crosslinker. The bead has a diameter no greater than 200 μm, no void spaces having a diameter greater than 5 μm, and less than 5 weight percent of organic extractables. In another variant, the polymer has from 0.5% to 1.6% crosslinker and the bead has a diameter no greater than 170 μm. The polymer is a styrene polymer with a divinylbenzene crosslinker in one variant of the invention. The polymer can have from 0.7 mole percent to 1.2 mole percent crosslinker, and the bead may have no void spaces having a diameter greater than 3 μm, and less than 3 weight percent of organic extractables. By way of example, the crosslinked polymeric bead has a diameter no greater than 150 μm.

Another example of creating the resin used in the present uses the following method: (a) preparing a suspension polymerization mixture in a vessel. The mixture comprises: (i) a monomer mixture comprising at least one vinyl monomer and at least one crosslinker; and (ii) from 0.25 mole percent to 1.5 mole percent of at least one free radical initiator; The method next includes removing oxygen from the suspension polymerization mixture and the vessel by introducing an inert gas for a time sufficient to produce an atmosphere in the vessel containing no more than 5 percent oxygen; allowing the monomer mixture to polymerize; and washing the bead with an aprotic organic solvent. The monomer mixture optionallycontains from 0.5 mole percent to 2 mole percent of at least one crosslinker, and the atmosphere in the vessel optionally contains no more than 2 percent oxygen.

Optionally, in one variant, the bead includes at least one vinyl monomer having at least 90 mole percent styrene. The crosslinker comprises divinylbenzene, and the bead has a diameter no greater than 200 μm.

This Example describes the preparation of a nine amino acid fragment of the peptide known as T-20, described in U.S. Pat. No. 6,015,881, Table 1, as Peptide No. 7, containing amino acids 18-35. U.S. Pat. No. 6,015,881 is incorporated herein by reference as if fully set forth. The kinetics of the reaction are followed by sampling resin periodically during the coupling and running a Kaiser test to determine the presence of any unreacted primary amine. The resins described above are used in the creation of the loaded resin, and then in the peptide build. The examples below show exemplary peptide builds. The results of this example are shown in table 4. It is appreciated that various combinations of peptide builds can be constructed using the techniques described herein.

It is appreciated that the methods described herein can be used for very low cost and efficient synthesis of peptides, in particular T-20, and T-20-like peptides. Such methods utilize solid and liquid phase synthesis procedures to synthesize and combine groups of specific peptide fragments to yield the peptide of interest. In other variant, individual peptide fragments which act as intermediates in the synthesis of the peptides of interest (e.g., T-20) are also created. In yet another aspect the present invention provides for the creation of groups of such peptide intermediate fragments which can be utilized together to produce full length T-20 and T-20-like peptides. One of ordinary skill in the art will appreciate that the cycle times for producing peptides, including but not limited to T-20 which include assembly of many smaller fragments, are in the aggregate also substantially reduced. Not only are cycle times reduced but waste is greatly reduced, and efficiency is greatly increased.

In another aspect, the peptides or fragments of peptides created by the processes described herein are purified, and/or the individual peptide fragments which act as intermediates in the synthesis of the subject peptides are also purified.

It is further appreciated that the invention can also be used to create peptides and peptide fragments which exhibit an ability to inhibit fusion-associated events, and, importantly, also exhibit potent antiviral activity. These peptides and peptide fragments are described in U.S. Pat. Nos. 5,464,933; 5,656,480 and PCT Publication No. WO 96/19495, incorporated by reference herein as expressly set forth. The invention provides a method for creating these therapeutics in large scale quantities.

T-20 and T-20 fragments are made using solid and liquid phase synthesis procedures to synthesize and combine groups of specific peptide fragments to yield the peptide of interest. Generally, the methods of the invention include synthesizing specific side-chain protected peptide fragment intermediates of T-20 or a T-20-like peptide on a solid support created by the invention described herein, coupling the protected fragments in solution to form a protected T-20 or T-20-like peptide, followed by deprotection of the side chains to yield the final T-20 or T-20-like peptide. A preferred embodiment of the methods of the invention involves the synthesis of a T-20 peptide having an amino acid sequence as depicted in U.S. Pat. No. 6,015,881 (“'881 patent”).

The present invention further relates to individual peptide fragments which act as intermediates in the synthesis of the peptides of interest (e.g., T-20). The peptide fragments of the invention include, but are not limited to, those having amino acid sequences as described in the '881 patent.

It is appreciated that the present invention can also create one or more peptide fragments using conventional techniques using CTC-resins, and create one or more peptide fragments using the techniques described herein using the alcohol based resins as described in our patent application filed Feb. 12, 2003 by Bohling et al., entitled “AMINO ACID LOADED TRITYL ALCOHOL RESINS, METHOD OF PRODUCTION OF AMINO ACID LOADED TRITYL ALCOHOL RESINS, AND BIOLOGICALLY ACTIVE SUBSTANCES AND THERAPEUTICS PRODUCED THEREWITH” docket no. DN A01485. The resulting peptides can thereafter be combined to obtain the T-20 peptides or T-20 like peptides.

It will be understood that the methods, fragments and groups of fragments and techniques utilized for choosing the fragments and groups of fragments of the present invention may be used to synthesize T-20-like fragments in addition to T-20. The term “T-20-like” as used herein means any HIV or non-HIV peptide listed in U.S. Pat. Nos. 5,464,933; 5,656,480 or PCT Publication No. WO 96/19495, each of which is hereby incorporated by reference in its entirety.

In addition to T-20 and the T-20-like peptides described above, the methods, fragments and groups of fragments of the present invention may be used to synthesize peptides having modified amino and/or carboxyl terminal ends.

The methods of the invention are used to synthesize the peptide having a formula wherein X is an acetyl group and Z is an amide group. In a preferred method, T-20 and T-20-like peptides and intermediates can be purified using any non-silica based column packing (for maximization of loading capacity) including but not limited to zirconium-based packings, poly-styrene, poly-acrylic or other polymer based packings which are stable at high (greater than >7) pH ranges. For example, among the non-silica-laded column packing exhibiting a broad pH range that includes pH valves greater than that are sold by Tosohaus (Montgomeryville, Pa.). Columns packed with such material can be run in low, medium or high pressure chromatography

The present invention also provides for large scale efficient production of peptide fragment intermediates of T-20 and T-20-like peptides with specific amino acid sequences as listed in Table 1 above of the '881 patent, and the groups of peptide fragment intermediates listed in Table 2 of the '881 patent. Such peptide intermediates, especially in groups as listed in Table 2 of the '881 patent are utilized to produce T-20 and T-20 like peptides.

Any one or more of the side-chains of the amino acid residues of peptide fragments may be protected with standard protecting groups such as t-butyl (t-Bu), trityl (trt) and t-butyloxycarbonyl (Boc). The t-Bu group is the preferred side-chain protecting group for amino acid residues Tyr(Y), Thr(T), Ser(S) and Asp(D); the trt group is the preferred side-chain protecting group for amino acid residues His(H), Gln(O) and Asn(N); and the Boc group is the preferred side-chain protecting group for amino acid residues Lys(K) and Trp(W).

During the synthesis of fragments, the side-chain of the histidine residue is be protected, preferably with a trityl (trt) protecting group. If it is not protected, the acid used to cleave the peptide fragment from the resin may detrimentally react with the histidine residue, causing degradation of the peptide fragment.

The glutamine residues of the peptide fragments of the invention are protected with trityl (trt) groups. However, it is possible not to protect the glutamine residue at the carboxy-terminal end of certain fragments. All the asparagine residues of each peptide fragment of the invention can be protected. In addition, the tryptophan residue is protected with a Boc group. Some of the individual peptide fragments are made using solid phase synthesis techniques described herein, while other peptides of the invention are optionally made using a combination of solid phase and solution phase synthesis techniques. The peptides of the invention may alternatively be synthesized such that one or more of the bonds which link the amino acid residues of the peptides are non-peptide bonds. These alternative non-peptide bonds may be formed by utilizing reactions well known to those in the art, and may include, but are not limited to imino, ester, hydrazide, semicarbazide, and azo bonds, to name but a few.

In yet another embodiment of the invention, T-20 and T-20 like peptides comprising the sequences described above may be synthesized with additional chemical groups present at their amino and/or carboxy termini, such that, for example, the stability, reactivity and/or solubility of the peptides is enhanced. For example, hydrophobic groups such as carbobenzoxyl, dansyl, acetyl or t-butyloxycarbonyl groups, may be added to the peptides' amino termini. Likewise, an acetyl group or a 9-fluorenylmethoxy-carbonyl group may be placed at the peptides' amino termini. Additionally, the hydrophobic group, t-butyloxycarbonyl, or an amido group may be added to the peptides' carboxy termini. Similarly, a para-nitrobenzyl ester group may be placed at the peptides' carboxy termini.

Further, T-20 and T-20-like peptides may be synthesized such that their steric configuration is altered. For example, the D-isomer of one or more of the amino acid residues of the peptide may be used, rather than the usual L-isomer.

Still further, at least one of the amino acid residues of the peptides of the invention may be substituted by one of the well known non-naturally occurring amino acid residues. Alterations such as these may serve to increase the stability, reactivity and/or solubility of the peptides of the invention.

Preferably, one or more the peptide fragments of the present invention are synthesized by solid phase peptide synthesis (SPPS) techniques described herein using standard FMOC protocols. See, e.g., Carpino et al., 1970, J. Am. Chem. Soc. 92(19):5748-5749; Carpino et al., 1972, J. Org. Chem. 37(22):3404-3409.

General procedures for production and loading of resins using conventional techniques can be used in addition to, or in combination with, the novel techniques described herein. Some fragments can be made using resin loading performed, for example, via the following techniques: The resin, preferably a super acid sensitive resin such as 2-chlorotrityl resin, is charged to the reaction chamber. The resin is washed with a chlorinated solvent such as dichloromethane (DCM). The bed is drained and a solution of 1.5 equivalents of an amino acid and 2.7 equivalents of diisopropylethylamine (DIEA) in about 8-10 volumes of dichloroethane (DCE) is added. The N-terminus of the amino acid should be protected, preferably with Fmoc, and the side chain of the amino acid should be protected where necessary or appropriate. The mixture is agitated with nitrogen bubbling for 2 hours. After agitation, the bed is drained and washed with DCM. The active sites on the resin are endcapped with a 9:1 MeOH:DIEA solution for about 20-30 minutes. The bed is drained, washed 4 times. with DCM and dried with a nitrogen purge to give the loaded resin. The fragment is then built following standard washing, deprotecting, coupling and cleaving protocols. Other fragments are made using the novel techniques described herein. The fragments made by the various techniques are then combined as described.

Fmoc is the preferred protecting group for the N-terminus of the amino acid. Depending on which amino acid is being loaded, its side chain may or may not be protected. For example, when Trp is loaded, its side chain should be protected with Boc. Similarly, the side-chain of Gln may be protected with trt. However, when Gln is being loaded in preparation for the synthesis of the 1-16 peptide fragment, its side chain should not be protected. It is not necessary to protect the side-chain of Leu.

The Fmoc-protected amino acids used in loading the resin and in peptide synthesis are available, with or without side-chain protecting groups as required, from Senn or Genzyme. Other exemplary peptides and fragments described in U.S. Pat. No. 6,281,331 (incorporated by reference herein as if fully set forth) can be made using the novel techniques described herein, alone or in combination with other conventional techniques.

The processes and substrates described herein can also be used to construct the polypeptide described in U.S. Pat. No. 6,469,136 (“'136 patent”), incorporated herein by reference as if fully set forth. In particular, peptides referred to herein as T-1249 and T-1249-like peptides can be constructed using the novel methods described herein, alone or in combination with the conventional methods described herein. These methods utilize solid and liquid phase synthesis procedures to synthesize and combine groups of specific peptide fragments to yield the peptide of interest.

Novel methods for the synthesis of peptides, in particular peptides referred to herein as T-1249 and T-1249-like peptides, are described herein. These methods utilize solid and liquid phase synthesis procedures to synthesize and combine groups of specific peptide fragments to yield the peptide of interest. Generally, the methods include synthesizing specific side-chain protected peptide fragment intermediates of T-1249 or a T-1249-like peptide on a solid support, coupling the protected fragments in solution to form a protected T-1249 or T-1249-like peptide, followed by deprotection of the side chains to yield the final T-1249 or T-1249-like peptide. A preferred embodiment of the methods of the invention involves the synthesis of a T-1249 peptide having an amino acid sequence as depicted in the '136 patent.

The present invention further provides a low cost, highly efficient method to construct individual peptide fragments which act as intermediates in the synthesis of the peptides of interest (e.g., T-1249). The peptide fragments of the invention include, but are not limited to, those having amino acid sequences as depicted in Table 1 of the '136 patent. Combinations of solid phase liquid phase synthetic reactions as described herein allow high purity T-1249 and T-1249-like peptides to be manufactured for on a large scale with higher throughput and higher yield than those described in the art. T-1249 and T-1249-like peptides may be synthesized on a scale of one or more kilograms.

Creation of Full-Length Peptides

The present invention is used to synthesize the peptide known as T-1249. T-1249 is a 39 amino acid residue polypeptide whose sequence is derived from HIV-1, HIV-2 and SIV gp41 viral polypeptide sequences. It will be understood that the methods, fragments and groups of fragments and techniques utilized for choosing the fragments and groups of fragments of the present invention may be used to synthesize T-1249-like fragments in addition to T-1249. The term “T-1249-like” as used herein means any HIV or non-HIV peptide listed in International Application No. PCT/US99/11219, filed May 20, 1999, International Publication No. WO 99/59615 published Nov. 25, 1999, which is hereby incorporated by reference in its entirety.

In addition to T-1249 and the T-1249-like peptides described above, the methods, fragments and groups of fragments of the present invention may be used to synthesize peptides having modified amino and/or carboxyl terminal ends. or other polymer based packings which are stable at high and low pH ranges.

Peptide Intermediates

One or more peptide fragment intermediates of T-1249 and T-1249-like peptides with specific amino acid sequences as listed in Table 1 of the '136 patent, and one or more groups of peptide fragment intermediates listed in Table 2 of the '136 patent are also constructed using the novel processes described herein, alone or in combination with other art processes.

Peptide Synthesis

Individual peptide fragments are preferably made using solid phase synthesis techniques, while other peptides of the invention are optionally made using a combination of solid phase and solution phase synthesis techniques. The syntheses culminate in the production of T-1249 or T-1249-like peptides.

The peptides of the invention may alternatively be synthesized such that one or more of the bonds which link the amino acid residues of the peptides are non-peptide bonds. These alternative non-peptide bonds may be formed by utilizing reactions well known to those in the art, and may include, but are not limited to imino, ester, hydrazide, semicarbazide, and azo bonds, to name but a few. Further, T-1249 and T-1249-like peptides may be synthesized such that their steric configuration is altered. For example, the D-isomer of one or more of the amino acid residues of the peptide may be used, rather than the usual L-isomer.

Still further, at least one of the amino acid residues of the peptides of the invention may be substituted by one of the well known non-naturally occurring amino acid residues. Alterations such as these may serve to increase the stability, reactivity and/or solubility of the peptides of the invention. Any of the T-1249 or T-1249-like peptides may be synthesized to additionally have a macromolecular carrier group covalently attached to its amino and/or carboxy termini. Such macromolecular carrier groups may include, for example, lipid-fatty acid conjugates, polyethylene glycol, carbohydrates or additional peptides.

Amino acid loaded resins are prepared using the novel techniques described herein. After agitation, the bed is drained and washed with DCM. The bed is drained, washed four times with DCM and dried with a nitrogen purge to give the loaded resin.

Fmoc is the preferred protecting group for the N-terminus of the amino acid. Depending on which amino acid is being loaded, its side chain may or may not be protected. For example, when tryptophan (Trp) is loaded, its side chain should be protected with Boc. However, it is not necessary to protect the side-chain of leucine (Leu). Preferably, glutamic acid (Glu), aspartic acid (Asp), threonine (Thr) and serine (Ser) are protected as t-butyl ethers or t-butyl esters, and tryptophan (Trp) and lysine (Lys) are protected as t-butoxycarbonyl carbamates (Boc). The amide side-chain of asparagine (Asn) and glutamine (Gln) may or may not be protected with trityl groups.

Meanwhile, the subsequent amino acid in the sequence to be added to the resin is activated for reaction at its carboxy terminus. The amine terminus of each amino acid is optionally protected with Fmoc. Depending on which amino acid is being added, its side chain may or may not be protected. Preferably, the side-chains of tyr(Y), Thr(T), Ser(S), Glu(E) and Asp(P) are protected with t-Bu, the side-chains of Gln(O) and Asn(N) are protected with trt, and the side-chains of Lys(K) and Trp(w) are protected with Boc. It is not necessary for the side-chains of Leu or Ile to be protected.

The amino acid can be activated as follows. The Fmoc-protected amino acid (1.5 eq), 1-hydroxybenzotriazole hydrate (HOBT) (1.5 eq), and diisopropyl-ethylamine (DIEA) (1.5 eq) are dissolved in a polar, aprotic solvent such as N-methylpyrrolidinone (NMP), dimethyl formamide (DMF) or dimethyl acetamide (DMAC) (about 7.5 vol.) at room temperature. The solution is chilled to 0-5 degrees C. and then O-benzotriazol-1-yl-N,N,N′,N′-tetramethyluronium hexafluorophosphate (HBTU) or O-benzotriazol-1-yl-tetramethyltetrafluoroborate (TBTU)(1.5 eq) is added followed by stirring for 5-15 minutes to dissolve. It is important that activation is carried out at 0-5 degrees C. to minimize racemization of the amino acid. The HBTU is the last reagent added to the cold solution since activation and racemization cannot take place in its absence.

The solution of activated amino acid is charged to the drained resin, washing in with DCM (approximately 2.5 vol). Note that activation of the amino acid is carried out in NMP due to the insolubility of HBTU in DCM. However, DCM is added to the reaction at this point to maintain adequate swelling of the resin beads. The reaction is agitated with N.sub.2 bubbling for about 1 hour at 20-30 degrees. C.

If the resin is to be stored overnight between coupling cycles, the resin bed may be drained and covered with NMP under a nitrogen blanket. Alternatively, the bed may be drained, stored under a nitrogen blanket, then conditioned with a DCM wash prior to proceeding with the next coupling cycle. If the completed fragment is to be stored overnight prior to cleavage, the resin bed should be washed free of NMP with IPA because significant Fmoc deprotection can occur in NMP.

After the coupling is judged complete, the resin is drained and washed with 3 aliquots (approximately 10 vol.) of NMP. The cycle is repeated for subsequent mers (i.e., amino acids) of the peptide fragment. Following the final coupling reaction, the resin is washed with 4 aliquots (about 10 vol.) of NMP, then with 2 aliquots (approximately 10 vol.) of DCM and 2 IPA. The resin-bound peptide may be dried with a nitrogen purge or in an oven.

Peptides synthesized via solid phase synthesis techniques can be cleaved and isolated according to, for example, the following non-limiting techniques: The peptide may be cleaved from the resin using techniques well known to those skilled in the art. For example, solutions of 1% or 2% trifluoroacetic acid (TFA) in DCM or a combination of a 1% and a 2% solution of TFA in DCM may be used to cleave the peptide. Acetic acid (HOAC), hydrochloric acid (HCl) or formic acid may also be used to cleave the peptide. The specific cleavage reagent, solvents and time required for cleavage will depend on the particular peptide being cleaved. After cleavage the cleavage fractions are subjected to standard work-up procedures to isolate the peptide. Typically, the combined cleavage fractions are concentrated under vacuum, followed by reconstitution with polar aprotic or polar aprotic solvents such as ethanol (EtOH), methanol (MeOH), isopropyl alcohol (IPA), acetone, acetonitrile (ACN), dimethyl formamide (DMF), NMD, DMAC, DCM, etc., followed by precipitation or crystallization with antisolvent such as water or hexanes, and collection by vacuum filtration. Alternatively, the product may be triturated with organic solvents or water after isolation of the peptide.

For synthesis of full length T-1249 peptides, the peptide intermediates, can be coupled together to yield the T-1249 peptide. For example, the groups of peptide intermediates, above, can be coupled together to produce T-1249 full-length peptide using the one or more of the methods described herein.

In certain embodiments, a three fragment approach for synthesis of T-1249 can be followed. A “three fragment approach” synthesis refers to a T-1249 synthesis scheme which begins with three T-1249 intermediate peptide fragments that are synthesized and coupled using solid and liquid phase synthesis techniques into a full-length T-1249 peptide.

Method for Solid Phase Peptide Synthesis (SPPS); General Procedure

A SPPS chamber is charged FmocLeu-resin (1 eq). The resin is conditioned in 5% piperidine DCM (7.5 vol) with a nitrogen purge for 15-30 minutes. The solvent is drained and the resin is treated with 2.times.20% piperidine in NMP (5 volumes) for 30 minutes to remove the Fmoc protecting group. After the second 20% piperidine/NMP treatment, the resin is washed with 5-7.times.NMP (5 vol) to a negative choranil test.

Meanwhile, the subsequent amino acid (1.5 eq), HOBT (1.5 eq) and DIEA (1.5 eq) are combined in 3:1 NMP/DCM (10 vol), allowed to fully dissolve at room temperature and cooled to 0 degrees C. HBTU is added, the solution is stirred for 10-15 minutes to dissolve the solid then added to the resin. The suspension is agitated with stirring under a nitrogen atmosphere for 1-3 hours. Coupling completion is monitored with a qualitative ninhydrin test. If the reaction is incomplete after 3 h (positive ninhydrin test persists) the reactor should be drained and a recoupling should be performed with a fresh solution of activated amino acid (0.5 eq). Normally after 30 min-1 h of recoupling a negative ninhydrin test is obtained. This cycle is repeated for the remaining amino acids in the fragment. As the fragment builds, the solvent volumes used in the washes may need to be increased from 5 volumes. Following the final coupling, the resin is washed with 3.times.5-8 volumes of NMP then 2.times.10 volumes of DCM and dried to constant weight in a vacuum oven at 40 degrees C.

Preferred Methods for Cleavage of the Peptide from Resin

The methods below describe the cleavage of peptide AcAA1-12OH from the resin. However, the same methods may be used for cleavage of other peptide fragments of the present invention.

Method A: Use of HOAc

The resin (1 g, 0.370 mmol) was treated with mixture of AcOH/MeOH/DCM (5:1:4, 20 vol, 20 mL) with nitrogen agitation for 1.5 h and the solution was transferred to a round bottom flask, stirred, and treated with water (20 vol). The resulting white slurry was concentrated (rotavap, 40 degrees. C bath) to remove DCM and the product collected by filtration. Drying to a constant weight affords 0.69 g (74%) of AcAA1-120H in 87A % purity. A second treatment of the resin as above provided an additional 0.08 g (8.5%) of AcAA1-12OH of less pure material (83 Area %) suggesting a desired reaction time of slightly >1.5 hr.

Method B: Use of TFA

The resin (1 wt., 20 g) is washed with 5-6.times.1.7 volumes of 1% TFA in DCM, 3-5 minutes each. The 1% TFA/DCM washes are collected in a flask containing pyridine (1:1 volume ratio with the TFA in the wash). The product containing washes are combined (600 mL, 30 vol) and the DCM is removed by distillation to a minimum pot volume (.about.⅓ the original volume). The vacuum is adjusted to maintain a pot temperature of 15-25 degrees C. Ethanol (6.5 vol) is added and the distillation is continued until the DCM is removed (as determined by an increase in the temperature of the distillate). Again the vacuum is adjusted to maintain a pot temperature of 15-20 degrees C. The final pot volume should be .about.8-9 volumes. The solution is cooled to 5-10 degrees C. and water (6.5 vol) is added over 30 minutes to precipitate the AcAA1-12OH. The solid is collected by vacuum filtration and washes with water (2-3 vol). The slurry is stirred at 0-5 degrees. C for 30 minutes, the solids are collected by vacuum filtration and dried to constant weight to give 16.80 g of AcAA1-12OH in 90% yield and 84 Area % (A %) purity.

SPPS of FmocAA27-38OH and Cleavage from the Resin

SPPS of FmocAA27-38OH was carried out as described above starting with 10 g of FmocTrp(Boc)OR loaded at 0.75 mmol/g. Cleavage method B was used (169/120/1, 78% yield, 87.9A %).

HPLC Conditions: Vydac C8, cat. No. 208TP54, 5 u, 300 A, 0.9 mL/min., 280 nm. A: 0.1% TFA/water, B: A mixture of 80% I-PrOH/20% Acetonitrile and 0.1% TFA. 60-80% B/30 min. Typical sample preparation: Dissolve 1 mg in 0.10 mL NMP, dilute with 1 mL Acetonitrile. Inject 20.mu.L into a 20.mu.L loop.

### Reduced Use of AA Equivalents Example

The process described herein has the unexpected result of using less reagent than conventional methods. It is appreciated that the cost of reagents including various amino acids is high. The present invention provides for significantly less reagent usage than convention techniques and therefor provides significant cost savings at scale up. In one variant, less than about 1.5 equivalents of the amino acid are used per equivalent of growing peptide chain. In one variant, less than about 1.4 equivalents of the amino acid are used per equivalent of growing peptide chain. In yet another variant, less than about 1.3 equivalents of the amino acid are used per equivalent of growing peptide chain. In yet a different variant, less than about 1.2 equivalents of the amino acid are used per equivalent of growing peptide chain. In yet a further aspect, less than about 1.1 equivalents of the amino acid are used per equivalent of growing peptide chain.

The loading efficiency of the current invention was compared with that found in the '881 patent by loading the resin of the current invention with the amino acid following the process of the '881 patent. The amount of amino acid charged was compared to the amount loaded and the efficiency calculated.

TABLE
Loading efficiency for several amino acids.

| | | |
|---|---|---|
| Leu | R + H | 89.4% |
| | ‘881 patent | 71.7% |
| Trp(Boc) | R + H | 66.5% |
| | ‘881 patent | 47.1% |
| Gln | R + H | 82.2% |
| | ‘881 patent | 63.8% |

For each of the three amino acids the loading efficiency was increased substantially using the present invention as compared with that described in the '881 patent. The reduced coupling times and increased loading efficiencies can also be correlated to reduced reagent usage during the formation of the peptide fragments. The reduced reagent usage at commercial scale results in significant cost savings and reagent use.

### Reduced Re-Coupling Example

Another unexpected result of the process used herein is the fact that re-couples are greatly reduced or eliminated all together. Conventional methods result in recouples for amino acid fragments greater than about 9 amino acids. The process used herein had the unexpected result that T-20 or T-1249 fragments having greater than about 10 amino acids did not require recouples. At scale, this a further significant advantage of the process described herein, and results in significant re-work savings. In another aspect, T-20 or T-1249 fragments having greater than about 15 amino acids were produced without recouples.

### Reduced Cycle Time Example

It was further determined that the present invention provides significantly reduced cycle times over conventional methods. At scale, this feature permits capacity limited facilities to reduce the cycle time for aa loads and peptide builds. This permits a production facility with set capability to increase throughput per cycle or shift. By way of example, cycle times can be reduced by as much as 50% over conventional methods. In one variant of the invention, a cycle time reduction in the range of about 15 minutes to about 30 minutes per cycle is accomplished. Where large peptide fragments are being synthesized, e.g. a decamer, the cycle time can be reduced by anywhere from 150 minutes to 300 minutes. It is appreciated that the cycle time savings in substantial where even larger peptides are being synthesized.

Recycling Example

| | Coupling Cycle Time (min) |
|---|---|
| Fmoc-L-AA-OH | R + H CTC |
| Asn (trt) | 15 |
| Typ (Boc) | 30 |
| Leu | 15 |
| Ser(t-Bu) | 30 |
| Ala | 15 |
| Typ (Boc) | 30 |
| Lys (Boc) | 30 |
| Asp (t-Bu) | 30 |
| Total Time | 195 |
| AA Coupling | 100% |

The resin described in this invention is recycled by removing the peptide using standard conditions, then converted to the chlorotrityl alcohol resin with sodium hydroxide. The chlorotrityl alcohol resin is then converted to CTC by treatment with thionyl chloride and a catalytic amount of dimethyl formamide in toluene. The increased durability of the low void space resin has lead to significantly improved perfect bead count and processability for the recycled resin compared to the resins currently found in the art.

### Amino Acid Yield Comparison Example

The process includes obtaining a load efficiency of amino acid greater than about 75% for 1 equivalent (“eq”) (per gram of CTC) FMOC-Leu and 1.35 eq (per molar equivalent of FMOC Leu) of diisopropylethyl amine in 10 mL dichlormethane/gram of CTC resin or 60% for 1 eq (per gram of CTC) FMOC-Trp(boc) and 1.35 eq (per molar eq of FMOC-Trp(boc)) of diisopropylethyl amine in 10 mL dichlormethane/gram of CTC resin and 75% for 1 eq (per gram of CTC) FMOC-Gln and 1.35 eq (per molar eq of FMOC Gln) of diisopropylethyl amine in 10 mL dichlormethane/gram of CTC resin.

In one variant, the invention provides an improved process for making a T-20 or a T-1249 composition, or a fragment of a T-20 or a T-1249 composition, using a chlorotrityl chloride linker-resin. The improvement comprises using a low void space resin optionally loaded with an amino acid or amino acid derivative to create one or more T-20 or T-1249 fragments. It is appreciated that in this variant less than 1.5 equivalents of the amino acid are used per equivalent of growing peptide chain, and the process optionally comprises providing a cycle time reduction in the range of about 15 minutes to about 30 minutes over conventional methods. The load efficiency increase provided of amino acid is greater than about a 7.5% increase over conventional resins.

In another variant, the process of claim 1 further comprises recycling the low void space resin. It is appreciated that one advantage of these variants of the invention is that a polypeptide fragment having greater than about 10 amino acids (or in another variant 15 aminoacids) can be prepared free of or substantially free of recouples.

In yet another variant of the invention, the process includes using a resin having functionality homogeneously disposed throughout the bead. In this variant, the process includes using a low void space resin to create one or more T-20 or T-1249 fragments.

The following example illustrates how to make jetted copolymer beads that are functionalized to make a resin used in the present invention. Copolymer beads of uniform particle size are produced by charging 150 ml of an aqueous heel containing 0.49% MHEC-8000, 0.4% boric acid, 0.19% NaOH and 0.02% NaNO2 to the reactor (9), pH is adjusted to 9.5-10, the mixture is then inerted with nitrogen for 15 minutes. The aqueous phase is used to fill the formation column (4) and the transfer line (6). A monomer phase (1) consisting of 97.2% styrene, 1.5% DVB (80% DVB, 20% EVB, charge based on total DVB/EVB charge), and 1.3% tert-butylperoxy-2-ethylhexanoate (% by weight), which was also inerted with nitrogen for 15 minutes, is fed to the monomer droplet generator (2) at a monomer flow rate of 45 ml/hr/hole, or 135 ml/hr total. The droplet generator (2) contains three 50 micron holes vibrationally excited at 17747 Hz. The aqueous feed (3) is fed to the formation column (4) at a flow rate of 148 ml/hr. The slurry is fed upflow through the transfer line (5) to the reactor (6). The agitator (7) is operated under conditions sufficient to suspend the droplets without sheardown, typically 250 rpm. The reactor (6) is fed for 3.6 hr under nitrogen to reach a mass basis aqueous to organic ratio of 1.4. This feed upflow through the transfer line is performed below reaction temperature (ambient). The reactor (6) is then heated to reaction temperature of 80 C and polymerized for 12 hr. After separating the copolymer beads from the aqueous phase and washing the beads following the process disclosed in previous examples the following properties are obtained: HMS 105 microns, and a uniformity coefficient of 1.11.

The following is an example of how to make seed expanded copolymer beads that are functionalized to make a resin used in the present invention. A reactor is charged with 20 g of polystyrene seed (50 mm in diameter) dispersed in 150 g of aqueous solution containing 0.2 g of Hydroxypropyl Methylcellulose stabilizer and buffered to pH 9.5 to 10 with a boric acid and sodium hydroxide. The suspension is heated to 80° C. over 45 minutes under nitrogen. 1.36 g of tert-butylperoxy-2-ethylhenoate is dissolved in 6.5 g of styrene, to the mixture is added 6 g of 0.95% Octylphenoxypolyethoxyethanol aqueous solution, the mixture is then sparged with nitrogen for 10 minutes. After emulsified the mixture is fed into above reactor over 15 minutes and held for 1 hr at 80° C. 0.45 g tert-butylperoxy-2-ethylhenoate is dissolved in 134 g of styrene and divinylbenzene mixture (1.2% DVB by weight) which is sparged with nitrogen for 15 minutes, to this mixture, 106 g surfactant aqueous solution (0.95% Octylphenoxypolyethoxyethanol) was added and emulsified. The resulting mixture is fed to the reactor over 6 hours. After all the monomers are added to the reactor, the reactor is held at 80° C. for an additional 12 hrs. The resulted beads are then washed by methods disclosed in earlier examples.

In one variant, the invention provides an improved process for making a T-20 or a T-1249 composition, or a fragment of a T-20 or a T-1249 composition. The process optionally includes using chlorotrityl chloride linkers covalently bound to resin beads, and the improvement comprises using a plurality of low void space resin beads, optionally loaded with an amino acid or amino acid derivative, to create one or more T-20 or T-1249 fragments. Within a vessel, there is a batch of beads that are used for synthesis. The batch contains low void space resin beads and beads containing void spaces which may be greater than 5 microns. At least fifty percent by count of all the resin beads in the vessel are low void space resin beads, e.g. have no void spaces greater than 5 microns, in one variant of the invention. The fact that there are greater than 50 percent by count low void space resin beads leads to decreased cycle times and reagent usage as shown herein. In another variant of the invention, at least 50 percent of the low void space resin beads have no void spaces having a diameter greater than 3 mm. In yet other variants, the plurality of functionalized resin beads having no void spaces having a diameter greater than 2 mm, and the plurality of low void space resin beads have no void spaces having a diameter greater than 1 mm.

In yet other variants of the invention, process includes functionalized resin beads that comprise at least seventy percent, at least eighty percent, at least ninety percent, or at least ninety five percent by count of all beads used to make a polypeptide material.

The method for determining the percentage count of compolymer beads which are functionalized to make functionalized resin beads, e.g. CTC-resin beads, included using a Nikon TE300™ inverted microscope. Copolymer samples were washed by contacting with 20 mL/g of tetrahydrofuran (“THF”) for 30 minutes then draining in a fritted disk filter. The resin beads were then contacted with another 10 mL/g of THF for 10 minutes with stirring, then drained. The resin beads were then contacted with a third wash of 10 mL/g of THF for 10 minutes with stirring, then drained. 5 mL/g of THF was added to the resin, the resin was then stirred until all resin was in suspension then 10 mL/g of Methanol was added. Stirring was continued for 5 minutes then allowed to drain to resin level. Another 10 mL/g was added with stirring and the stirring continued for 5 minutes. The solvent was then drained completely. The resin beads were then washed with a third portion of methanol 10 mL/g stirred for 5 minutes then drained completely. The final methanol wash was then repeated, drained completely, and vacuum pulled through the sample for 15 minutes. The resin beads were then transferred to a vacuum oven and dried at 35 degrees C. over night. Resin beads were placed dry, onto a microscope slide and analyzed on either an inverted microscope, (Nikon TE300), or Standard Zeiss Stemi 2000C and the images captured with a Media Cybernetics Cool Snap Digital camera and Image Pro 4 software. The resins were initially viewed at low magnification on the Zeiss Stemi microscope, if no or few void spaces were noted the resin beads were transfered to the Nikon TE300 and analyzed at 4× and 10× for beads for void spaces. Visual determination of the count of resin beads having void spaces was made. If beads having void spaces were found, the size of voids were then measured by looking at a still photograph of the resin beads with appropriate calibration.

The following method for determining the percentage of functionalized resin beads having void spaces of a certain size was used in relation to a total number of functionalized resin beads was used. Sample batches of resin beads having CTC linker groups thereon were analyzed as follows: Resin beads were placed dry, onto a microscope slide and analyzed on either an inverted microscope, (Nikon TE300), or Standard Zeiss Stemi 2000C and the images captured with a Media Cybernetics Cool Snap Digital camera and Image Pro 4 software. The resins were initially viewed at low magnification on the Zeiss Stemi, if no or few void spaces were noted on the functionalized resin beads, the resin was transfered to the Nikon TE300 and analyzed at 4× and 10× for beads with void spaces.

The process for counting void spaces by count (for both copolymer beads and functionalized resin beads, e.g. a resin bead having a CTC or other linker group thereon) is to adjust the microscope to have a single layer of beads and the light adjusted to allow for clear viewing of the beads. The number of beads on the screen are then counted. The focus on the microscope is then varied to allow focused viewing of the different depths within the resin. At higher magnification the focus is so tight that one focus setting does not allow one to see the entire depth of the bead. As the focus is scanned, beads with void spaces are counted, and if available a photo is taken and the size of the void measured electronically. This process is repeated until a representive statistically significant sample is obtained. The number of beads with void spaces over 5 microns is divided by the total number of beads and multiplied by 100 to obtain the percent of beads with void spaces. This number can be subtracted from 100 to obtain the % void free bead count.

By way of example, the following cop olymer batches were analyzed for low void space bead count:

| | Percentage of copolymer beads having |
|---|---|
| Batch | low void spaces |
| Batch A | 99.2% (having void spaces less than 5 |
| | microns) |
| Batch B | 98.4% (having void spaces less than 2 |
| | microns) |
| Batch B | 97.1% (having void spaces less than |
| | 1.25 microns) |

By way of example, the following functionalized resin bead batches were analyzed for low void space bead count:

| | Percentage of copolymer beads having |
|---|---|
| Batch | low void spaces |
| Batch C | 99.4% free of voids over 5 micron |
| Batch C | 90.8% free of voids over 3 micron. |

Batch C was made from Batch B. The resin in Batch B was functionalized by the covalent addition of a CTC-linker.

In another variant, a plurality of resin beads comprise 0.5 to 1.5 mole percent DVB. DVB is used to hold the resin beads together so that they don't disintergrate and deform when used in commercial scale manufacture. For example, a typical vessel may have in the range of 20-50 cm of resin in a vessel. If an inappropriate amount of DVB is used, the resin may compress and deform, and result in undesirable pressure drop in a vessel. Since there is very little DVB in the resins of the current invention, a small change in DVB level makes a big difference in resistance in deformability. Where there are undesirable void spaces and low amounts of DVB used, the resin beads are even less processable. The combination of a low void space functionalized resin using 0.5 to 1.5 mole percent DVB provides a resin that resists deformation in commercial reaction vessels. This provides a resin that has lower swelling than competitive resins while simultaneously providing excellent coupling kinetics.

These coupling kinetics permit the use of less than or equal to 1.5 equivalents of a subsequent amino acid to grow T-20 or T-1249 fragments with reduced cycle times as described herein while eliminating or substantially reducing the number of recouples that need to be performed. The process, at commercial scale, provides for a long T-20 or T-1249 fragment (e.g. a fragment greater than 10 amino acid sequences) comprising a terminal amino acid or terminal amino acid derivative, to have coupled to the terminal amino acid or the terminal amino acid derivative a subsequent amino acid readily, and without the need for frequent recoupling.

In another aspect, the invention provides a process further comprising recycling the plurality of low void space resin beads. The durability of the resins of the present invention provide the ability to recycle the resin beads after cleavage of the peptide fragment made thereon. This is due to the fact that there is decreased bead attrition with the resins of the present invention. In one variant, a plurality of recylces can be accomplished. This provides a significant economic advantage and reduced waste costs since resin batches do not need to be disgarded after every very fragment build. The cost of a new batch of resin is also saved.

The process also uses copolymer beads made with divinylbenzene having a purity from 55% to 82%. These copolymer beads are then functionalized with appropriate linkers. Copolymer beads are optionally produced by jetting or seed expansion as described in the examples below. The functionalized resin beads also are spherical copolymer beads having a particle diameter in the range of 100 to 200 microns in one variant of the invention and the copolymer resin beads from which the functionalized resin beads are produced by suspension polymerization in another variant of the invention. In an aqueous phase of a suspension polymerization mixture, it is desired to maintain the pH from 9 to 11.5. In another variant a pH above 8 can also be used.

The copolymer resin beads are made using a polymerization initiator selected from the group consisting a peroxide, a hydroperoxide, a peroxyester, a benzoyl peroxide, a tert-butyl hydroperoxide, a cumene peroxide, a tetralin peroxide, an acetyl peroxide, a caproyl peroxide, a tert-butyl peroctoate, a tert-butyl perbenzoate, a tert-butyl diperphthalate, a dicyclohexyl peroxydicarbonate, a di(4-tert-butylcyclohexyl)peroxydicarbonate, a methyl ethyl ketone peroxide, an azo initiator, an azodiisobutyronitrile, an azodiisobutyramide, a 2,2′?azo-bis(2,4-dimethylvaleronitrile), a azo-bis(a-methyl-butyronitrile), a dimethyl-azo-bis(methylvalerate), a diethyl-azo-bis(methylvalerate), and a dibutyl azo-bis(methylvalerate). Fewer bubbles are generated when benzoyl peroxide is not used. A preferred initiator is tert-butyl peroctoate.

In another variant, copolymer resin beads are prepared using an optional enzyme treatment to cleanse a surface of said resin beads. The enzyme treatment comprises contacting a polymeric phase with enzymatic material during polymerization, following polymerization, or after isolation of a polymer. The enzymatic material is selected from the group consisting of a cellulose-decomposing enzyme, a proteolytic enzyme, a urokinase, an elastase and an enterokinase.

In yet another variant, the copolymer resin beads are produced by a method comprising: (a) preparing a suspension polymerization mixture in a vessel; said mixture comprising: (i) a monomer mixture comprising at least one vinyl monomer and at least one crosslinker; and (ii) from 0.25 mole percent to 1.5 mole percent of at least one free radical initiator; (b) removing oxygen from the suspension polymerization mixture and the vessel by introducing an inert gas for a time sufficient to produce an atmosphere in the vessel containing no more than 5 percent oxygen; (c) allowing the monomer mixture to polymerize; and (d) optionally washing the beads with a swelling solvent.

In another variant, the improved process for making a polypeptide composition, or a fragment of a polypeptide composition, optionally using linkers covalently bound to resin beads includes using a plurality of functionalized resin beads made from copolymer comprising less than 5% organic extractables.

The term “organic extractables” as used herein means residual monomers. The following process was used to determine percentage residual monomer in copolymer beads. Residual monomer levels are reported as percent species per gram dry resin. Prior to dichloromethane (“DCM”) extraction, a portion of each sample is taken and the percentage solids determined. Loss on drying is done in a 105 degrees C. oven over a 12 hour period. DCM extraction is performed on the portion which is not placed in the oven. Approximately 1 gram of dry copolymer resin beads were added to a tared loz vial and the weight recorded. HPLC grade DCM (15.0 mls) was added to the vial and the weight was recorded. The vial was capped and mechanically shaken for one hour. After shaking, the resin was allowed to float in the DCM for 10 minutes. A 2 ml aliquot of the DCM extract was removed from the vial using a borosilicate transfer pipette. The aliquot was transferred to a disposable syringe fitted with a 0.5 um Millex™ LCR filter. The filtrate is transferred into a gas chromotagraphy (“GC”) vial and capped.

Analytical standards for each analyte is prepared by serially diluting a 10,000 ppm stock solution prepared in dichloromethane. The area counts for each analyte are regressed linearly to obtain calibration curves for each analyte. Correlation coefficients are >0.998. Analysis of the DCM extracts is done using an HP (Hewlett Packard) 5890 Gas Chromatograph (GC) equipped with a Flame Ionization Detector (“FID”) in the splitless mode using an autoinjector/autosampler (eg. HP 7673A autosampler). The following conditions were used:

Column: Chrompack WCOT fused silica column, 25 m×0.25 mm id, coated with CP-SIL 5CB, DF=0.25; Carrier gas: helium; Column pressure: 11.9 psi; Carrier flow rate: 1.3 ml/min; Column temperature profile: 35° C. for 10 minutes, followed by a ramp of 4° C./min to 240° C., followed by a hold at 240° C. for 10 minutes; Equilibrium time is 1 minute; Detector: Flame Ionization; Detector temp: 350° C.; Injector temp: 250° C.; and, Injection: Splitless, injection volume=2 ul, 30 second purge delay

Peaks are identified by matching retention times to the external standards mentioned above within a window of 0.3/minute. Residual monomers are reported as part per million (ppm) found in the solution, from which the ppm per gram of resin are then calculated and reported.

Exemplary copolymer is made using the following process: Deionized (“DI”) water was charged to a round bottom flask, stirred at 150 rpm and heated to 80° C. under a nitrogen sweep. When the temperature was reached, the flask was charged slowly with 4.40 g of QP-300 (hydroxyethylcellulose dispersant, obtained from Union Carbide Co., Institute, WV). The temperature was maintained for 60 minutes at 80° C., after which the aqueous solution was cooled to 25° C. to 30° C. The following were charged to the flask: a solution of 200 g DI water and 0.95 g of Marasperse N-22 (sodium lignosulfate dispersant, obtained from Borregaard LignoTech, Rothschild, Wis.), 2.4 g 50% NaOH, 2.5 g boric acid, 0.036 g sodium lauryl sulfate and 0.1 g sodium nitrite. The contents of the flask were stirred for 30 minutes.

The monomer mixture was prepared in a separate beaker by charging the following: 6.55 g 80% DVB (divinylbenzene), 440.0 g styrene, 5.8 g Trigonox 21 (t-butyl peroxy-2-ethylhexanoate, obtained from Noury Chemical Corp., Burt, N.Y.). The mixture was transferred to an addition funnel and sparged with nitrogen for 40 minutes.

The agitator speed was adjusted to 275 rpm in the round bottom flask containing the aqueous phase before charging the monomer mixture to the flask. The agitator was stopped and the monomer mixture was charged to the aqueous solution, taking care to position the addition funnel so as not to introduce air to the monomer solution. After charging the monomer mixture, agitation was resumed and continued for 30 minutes at 25° C. The temperature was increased to 84° C. over 1 hour and maintained there for 12 hours.

The batch was cooled to 45° C., and the pH adjusted to 5.0 with HCl (37%). Cellulase™ 4000 (19.05 g) (cellulase enzyme, obtained from Valley Research, South Bend, Ind.) was charged to the batch, and stirred for 2 hours at 45° C. After the 2 hour hold, a second charge of Cellulase™ 4000 was added and the temperature maintained for 2 hours at 45° C. At the end of the hold period the batch was cooled to room temperature, removed from the flask and washed with DI water.

The yield of polymeric beads is approximately 90-100%. Previously, some polymer was lost due to agitator fouling or dispersion in the aqueous phase. The level of residual monomer varies with several parameters, including the thoroughness of the inertion with nitrogen, purity of DVB, and initiator level, as illustrated in the Table below. Inertion of reactants or reaction vessel was not performed, except as noted.

TABLE

| Initiator¹, | DVB | Residual | |
|---|---|---|---|
| weight % | purity, % | Styrene, % | Comments |
| 1.29 | 80 | 3.6 | monomer, aqueous not inerted |
| 1.29 | 80 | 0.6 | full inertion as described in |
| | | | procedure given above |
| 1.29 | 55 | 8.6 | added to achieve same DVB level |
| 1.29 | 80 | 3.7 | |
| 1.29 | 55 | 2.5 | full inertion |
| 1.29 | 80 | 3.6 | |
| 2.30 | 80 | 8.5 | |

By way of example, the copolymer beads are washed according to the following procedure. A 4.4 cm diameter, 50 cm long column is loaded with 100 mL of the copolymer beads. The copolymer beads are washed with 8 bed volumes of aprotic organic solvent at a flow rate of 0.5 bed volumes/hour in a down flow direction. The bed is washed with 4 bed volumes of methanol or water at a flow rate of 0.5 bed volumes/hour in a down flow direction. The bed is dried in a stream of nitrogen and then dried under vacuum at 45° C. for 18 hours.

In variants of the invention, the functionalized resin beads are made from copolymer beads comprising less than 3% of organic extractables, less than 2% organic extractables, or less than 1% organic extractables. As the level of organic extractables decreases in the copolymer beads from which the functionalized beads are made, the number of beads with void spaces also decreases. Since the copolymer is substantially devoid of void spaces, the resulting functionalized resin is also substantially devoid of void spaces.

Depending on the copolymer formed, the copolymer resin beads are prepared using a process that leaves an amount of organic extractable material present in the resin beads after manufacture thereof to reduce the formation of void spaces in the resin beads after washing with a solvent such that 50% or more of said resin beads by count comprise void spaces no greater than 5 microns.

In another variant, the process for making a T-20 or T-1249 polypeptide composition, optionally using linkers covalently bound to resin beads includes using a plurality of resin beads functionalized using a nitro-containing compound. Exemplary nitro-containing compounds include a C1-C6 nitroalkane, a nitro-aryl, or combination thereof. Nitro-benzene is also an exemplary nitro-compound that is used in the invention which provides excellent functionalization properties. Nitro-compounds coordinate with lewis acid catalyst making the catalyst bulky and soluble in solvents. These properties permit the catalyst to funtionalize the sterically most accessible sites in and on the copolymer resin beads. By functionalizing the most accessible sites, one improves the mass transfer of reagents into the functionalized resin beads and products, and by-products out of the functionalized resin beads. By of example, the activated amino acids have greater accessibility to the growing peptide chains which allows the use of less reagent and/or provides for reduced cycling times.

In yet another variant, the improved process for making a polypeptide composition, including e.g. T-20 and T-1249, or a fragment of a polypeptide composition, includes using a plurality of functionalized resin beads prepared using a chloride corrosion resistant filter. In one variant, the chloride corrosion resistant filter comprises a nickel alloy filter. By way of example, a nickel alloy filter is a Hastalloy™ filter commercially available from Rosenmund, Inc. (Charlotte, N.C.) or Rosenmund VTA, AG (Liestal, Switzerland). In alternate variants, the chloride corrosion resistant filter is selected from the group consisting of a glass lined filter or a Teflon™ lined filter. If the functionalized resin beads that are used to make a polypeptide are not made using a chloride corrosion resistant filter but a filter that is not chloride corrosion resistant, undesireable coloration results in a difficultly in conducting a colorometric Kaiser test to determine the completion of peptide build reactions. Discolorization or leaching of color from a resin is undesirable, and the invention eliminates or substantially reduces this problem. Iron from conventional non chloride corrosion resistant filters lodges in the resin matrix and must be washed out. Use of the chloride corrosion resistant filters eliminates of substantially reduce this problem.

The following example illustrates the utility of using a chloride corrosion resistant filter in the process for making functionalized beads use in the current invention: Three batches of 2′Chlorotrity chloride resin were produced following a scaled up version of the process disclosed in U.S. patent application Ser. No. 10/636,186, filed on Aug. 7, 2003, and U.S. Provisional Patent Application serial No. 60/404,044 entitled: RESIN FOR SOLID PHASE SYNTHESIS, filed on Aug. 16, 2002 (A1407). The campaign was run with 3 batches of step one as described in the above mentioned U.S. Patent Applications, then 3 batches of step 2 then finally 3 batches of step 3 in the patent application. Batch integrity was maintained throughout the campaign. After the first batch of step 3, the filter (A conventional stainlesss steel filter made from alloy SS316) was found to have turned slightly green, after resin discharge and sitting overnight. Product was slightly more colored than previous batches and Iron (130 ppm) was found. The second batch was processed and was found to be darker with a higher iron level (319 ppm). The final batch was processed and found to be brown colored and had the highest iron level (429 ppm). Corrosion coupons in the effluent from the filter confirmed that the solution was corrosive to alloy SS316 with pitting. Coupons of Hastalloy™ C276 filter were also included in the test an found to have acceptable corrosion rates and no pitting.

It is appreciated that the functionalized resin beads using the chloride corrosion resistant filter have, one or more of the following characteristics in a variant of the invention: the resin beads comprise 0.5% to 1.5% DVB; the resin beads have CTC linkers thereon; one gram of said resin beads will swell to between four to seven cubic centimeters; the resin beads are made from copolymer comprising less than 3% of organic extractables; the resin beads are made from copolymer comprising less than 2% organic extractables; and, the resin beads are made from copolymer comprising comprise less than 1% organic extractables. Other characteristics of the resin beads can also be incorporated into this variant of the invention as described herein.

It is appreciated that the processes described herein make the commercial scale manufacture of polypeptide commercially viable, as distinguished over conventional lab scale processes. The processess herein are performed in an industrially sized vessel. The industrially sized vessel by way of example, has a capacity of at least 50 liters, and can range in capacity from 50 liters to greater than 200 liters. In yet another variant, the industrially sized vessel has a filtering surface of at least one half square meter. In yet another variant of the invention, the improved process for making a polypeptide composition includes using a plurality of free flowing resin beads to create one or more polypeptide fragments. The free flowing resin beads are prepared under agitation with a non-swelling solvent after washing thereof and before drying thereof.

On a commercial scale, if one dries directly lightly crosslinked (functionalized and non-functionalized) resins, by way of example, 1% cross linked, styrene DVB functionalized resins after being in any swelling solvent, e.g. after washing, the product becomes non-free flowing (e.g. clumped). As a result of this, subsequent steps are made more difficult, and product performance is degraded. As a result of the clumping phenomenon, during subsequent processing beads on the outside of the clump become over functionalized while beads in the interior of the clump are underfunctionalized. For example, when resins are made, when the resin is charged to a reactive mixture, a mixture of undesirable products is obtained, i.e. dark beads are formed. These dark beads are over functionalized. When one builds a peptide, one wants a uniform distribution of functional groups from bead to bead so that the growing peptide chains are not sterically constrained. Use of free flowing beads of the present invention in peptide synthesis provides a uniform distribution of functional groups from bead to bead so that the growing peptide chains are not sterically constrained.

The present invention also uses beads that do not clog feed tubes, funnels and other manufacturing components. This means that entire systems need not be shut down and cleaned or designed with larger components. It is also appreciated that the processes described herein provide uniform batches of beads that do not contain beads that are overfunctionalization and beads that are undefunctionalization as seen by microscopic analysis, e.g. they do not include beads with intrabatch variability. Underfunctionalized beads are undesirably inert, and beads that are discolored indicate overfuntionalization which is also undesirable.

The present invention uses beads made by a method for producing free flowing resin beads comprising: prior to drying, shrinking the resin under agitation. Shrinking comprises charging a de-swelling solvent to a vessel. Agitation includes using one or more of the following, alone or in combination, mechanical mixing, tumbling, countercurrent charging, providing kinetic energy to the resin, lifting the resin beads from a resin bed using pneumatic or vibtrational devices, fluidizing the resin, expanding a resin bed, and/or charging solvent in from a bottom of a resin bed into the resin. In one variant, the vessel includes a filter.

In another aspect, the invention provides a process of making a peptide using the free flowing resin described herein, and a polypeptide made using the process.

In yet another aspect, the invention uses functionalized resin batches in which there is substantial bead to bead uniformity. The method by which the uniform beads are made includes contacting a non-packed resin bed with a non-swelling solvent. The resin is dispersed in a swelling solvent, and the method allows one to obtain a reduced volume resin product. Moreover, the method includes drying the reduced volume resin product obtained in the step above. Moreover, the resin beads are is non-clumping.

In another aspect the present invention uses functionalized resins made by a method for producing free flowing resin comprising the steps of contacting a resin dispersed in a swelling solvent and subsequently adding a non-swelling solvent to the dispersed resin obtain a resin that is reduced in volume; and, drying the reduced volume resin obtained above.

The following example illustrates the use of methanol in the invention yielding a substantially free flowing functionalized resin. A slurry of approximately 59 kg polymer bound (1% DVB/Styrene) 2′chlorobenzophenone in 442 L of THF was contained in a neutche filter. The resin bed was allowed to settle and the THF was drained to 2 inches above resin level. The resin solvent mixture was then agitated to fully disperse resin in the solvent and 275 L of methanol was added while agitating, mixing was continued for 15 minutes. Resin bed is allowed to settle then drained to top of resin level. 92 L of Methanol was then added and the mixture was agitated for 15 minutes then drained completely. Nitrogen was passed through the bed to completely drain. The resin was then dried in 35° C. vacuum oven to a constant weight. A free flowing product was obtained which has similar free-flow characteristics to the free-flow characteristics of water.

The follow example describes a process using hexane which gives a free flowing functionalized CTC-resin. A slurry of approximately 55 kg polymer bound (1% DVB/Styrene) 2′chlorotrityl chloride in 330 L of toluene was contained in a neutche filter. The resin bed was allowed to settle and the toluene was drained to 2 inches above resin level. The resin solvent mixture was then agitated to fully disperse resin in the solvent and 227 L of hexane was added while agitating. Mixing was continued for 15 minutes. The resin bed was allowed to settle then drained to top of resin level. 87 L of hexane was then added to the top of resin bed, agitated for 15 minutes then drained to the top of the resin bed. This step can optionally be repeated. Nitrogen was passed through the bed to completely drain. The resin was then dried in 35° C. vacuum oven to a constant weight. A product was obtained which has free flowing characteristics similar to the free flow characteristics of water.

This example illustrates a process using isopropyl alcohol (“IPA”) which gives free flowing Leucine loaded CTC-resin. A slurry of Approx 10 g polymer bound (1% DVB/Styrene) FMOCLeucine loaded 2′chlorotrityl chloride in 55 mL of DMF was contained in a buchner filter. The resin bed was allowed to settle and the DMF was drained to just above resin level. The resin solvent mixture was then agitated to fully disperse resin in the solvent and 55 mL of IPA was added while agitating, mixing was continued for 15 minutes. Resin bed is allowed to settle then drained to top of resin level. 55 mL of IPA was then added to the top of resin bed, agitated for 15 minutes then drained to the top of the resin bed. This step can optionally be repeated one or more times. Nitrogen was passed through the bed to completely drain. The resin was then dried in 35° C. vacuum oven to a constant weight. A product exhibiting excellent non-clumping, free-flowing characteristics which make the product suitable for re-packaging applications from bulk to smaller containers.

In another variant, the process for making a T-20 or T-1249 composition, or a fragment thereof includes using functionalized resin beads having a homogeneous density to create one or more polypeptide fragments. As used herein the term “homogeneous density” means, when dry beads are contacted with DMF and observed under a microscope, the swollen portions of individual beads within a group of beads have the same depth or substantially the same depth before the beads become fully swollen as noted by the disappearance of an unswollen core. In other variants, greater than 50%, greater than 60%, greater than 70%, greater than 80%, or greater than 90% of resin beads are homogeneous within a batch of beads used for peptide synethesis.

While only a few, preferred embodiments of the invention have been described hereinabove, those of ordinary skill in the art will recognize that the embodiment may be modified and altered without departing from the central spirit and scope of the invention. Thus, the preferred embodiment described hereinabove is to be considered in all respects as illustrative and not restrictive, the scope of the invention being indicated by the appended claims, rather than by the foregoing description, and all changes which come within the meaning and range of equivalency of the claims are intended to be embraced herein.

We claim:

1. An improved process for making a T-20 or a T-1249 composition, or a fragment of a T-20 or a T-1249 composition, optionally using chlorotrityl chloride linkers covalently bound to resin beads, in which said improvement comprises:
using a plurality of low void space resin beads, optionally loaded with an amino acid or amino acid derivative, to create one or more T-20 or T-1249 fragments, said low void space resin beads having no void spaces greater than 5 μm, and said low void space resin beads comprising at least fifty percent by count of all resin beads used to make said T-20 or said T-1249 composition.

2. The process of claim 2 in which said plurality of low void space resin beads comprise a plurality of beads having no void spaces greater than 3 μm.

3. The process of claim 3 in which said plurality of low void space resin beads comprise a plurality of beads having no void spaces greater than 2 μm.

4. The process of claim 4 in which said plurality of low void space resin beads comprise a plurality of beads having no void spaces greater than 1 μm.

5. The process of claim 1 in which said low void space resin beads comprise chlorotrityl chloride linkers covalently bound thereto, and in which said low void space resin beads are loaded with one or more amino acids or amino acid derivatives.

6. The process of claim 1 in which said plurality of resin beads comprise 0.5 to 1.5 mole percent divinylbenzene.

7. The process of claim 1 in which said beads comprise one or more amino acids covalently linked thereto, the process further comprising adding to said T-20 or T-1249 fragments less than or equal to 1.5 equivalents of a subsequent amino acid to grow said T-20 or T-1249 fragments.

8. The process of claim 1 in which said T-20 or T-1249 fragment comprises a terminal amino acid or terminal amino acid derivative, the process further comprising coupling to said terminal amino acid or said terminal amino acid derivative a subsequent amino acid.

9. The process of claim 1 in which said plurality of resin beads having said T-20 or T-1249 fragments thereon are capable of being coupled to a subsequent amino acid or amino acid derivative such that within less than 2 hours a negative Kaiser test is observed.

10. The process of claim 1 further comprising recycling said plurality of low void space resin beads.

11. The process of claim 1 further comprising preparing a T-20 or T-1249 fragment having greater than about 10 amino acids, said process being free of recouples.

12. The process of claim 1 further comprising preparing a T-20 or T-1249 fragment having greater than about 15 amino acids, said process being free of recouples.

13. The process of claim 1 further comprising assembling one or more of said T-20 or T-1249 fragments.

14. A T-20 or T-1249 composition, in which one or more fragments of T-20 or T-1249, are made by the process of claim 1.

15. An improved process for making a polypeptide composition, or a fragment of a polypeptide composition, optionally using chlorotrityl chloride linkers covalently bound to resin beads, in which said improvement comprises:
using a plurality of resin beads having no void spaces greater than 5 μm, said resin beads being optionally loaded with an amino acid or amino acid derivative, to create one or more polypeptide fragments, said resin beads comprising at least sixty percent by count of all beads used in a vessel that is used to make said polypeptide composition.

16. The process of claim 15 in which said resin beads comprise at least seventy percent by count of all beads.

17. The process of claim 16 in which said resin beads comprise at least eighty percent of beads by count of all beads.

18. The process of claim 17 in which said resin beads comprise at least ninety percent of beads by count of all beads.

19. The process of claim 18 in which said resin beads comprise at least ninety five percent of beads by count used to make said polypeptide material.

20. The process of claim 18 in which each of said resin beads comprise 0.5 to 1.5 percent divinylbenzene.

21. The process of claim 20 in which said resin beads are made with divinylbenzene having a purity from 55% to 82%.

22. The process of claim 15 in which said resin beads are produced by jetting or seed expansion.

23. An improved process for making a polypeptide composition, or a fragment of a polypeptide composition, optionally using chlorotrityl chloride linkers covalently bound to resin beads, in which said improvement comprises:
using a plurality of resin beads having no void spaces greater than 5 μm, said resin beads being optionally loaded with an amino acid or amino acid derivative, to create one or more polypeptide fragments, said resin beads comprising at least sixty percent by count of all beads used to make said polypeptide composition, all said resin beads comprising spherical copolymer beads having a particle diameter in the range of 75 to 200 microns, and said resin beads being produced by suspension polymerization.

24. The process of claim 23 in which said resin beads are made using one or more monomers, and made in an aqueous phase of a suspension polymerization mixture which is maintained at a pH from 9 to 11.5.

25. The process of claim 24 in which said resin beads are made using a polymerization initiator selected from the group consisting a peroxide, a hydroperoxide, a peroxyester, a benzoyl peroxide, a tert-butyl hydroperoxide, a cumene peroxide, a tetralin peroxide, an acetyl peroxide, a caproyl peroxide, a tert-butyl peroctoate, a tert-butyl perbenzoate, a tert-butyl diperphthalate, a dicyclohexyl peroxydicarbonate, a di(4-tert-butylcyclohexyl)peroxydicarbonate, a methyl ethyl ketone peroxide, an azo initiator, an azodiisobutyronitrile, an azodiisobutyramide, a 2,2′?azo-bis(2,4-dimethylvaleronitrile), a azo-bis(a-methyl-butyronitrile), a dimethyl-azo-bis(methylvalerate), a diethyl-azo-bis(methylvalerate), and a dibutyl azo-bis(methylvalerate).

26. The process of claim 23 in which said resin beads are prepared using an enzyme treatment to cleanse a surface of said resin beads.

27. The process of claim 26 in which said enzyme treatment comprises contacting a polymeric phase with enzymatic material during polymerization, following polymerization, or after isolation of a polymer.

28. The process of claim 27 in which said enzymatic material is selected from the group consisting of a cellulose-decomposing enzyme, a proteolytic enzyme, a urokinase, an elastase and an enterokinase.

29. The process of claim 23 in which said resin beads are produced by a method comprising: (a) preparing a suspension polymerization mixture in a vessel; said mixture comprising: (i) a monomer mixture comprising at least one vinyl monomer and at least one crosslinker; and (ii) from 0.25 mole percent to 1.5 mole percent of at least one free radical initiator; (b) removing oxygen from the suspension polymerization mixture and the vessel by introducing an inert gas for a time sufficient to produce an atmosphere in the vessel containing no more than 5 percent oxygen; (c) allowing the monomer mixture to polymerize; and (d) optionally washing the beads with a swelling solvent.

30. The process of claim 23 in which said resin beads are made from copolymer comprising less than 5% of organic extractables.

31. The process of claim 30 in which said resin beads are made from copolymer comprising less than 3% of organic extractables.

32. The process of claim 31 in which said resin beads are made from copolymer comprising less than 2% organic extractables.

33. The process of claim 32 in which said resin beads are made from copolymer comprising comprise less than 1% organic extractables.

34. The process of claim 23 in which said resin beads are prepared using a process that leaves an amount of organic extractable material present in said resin beads after manufacture thereof to reduce the formation of void spaces in the resin beads after washing with a solvent such that 50% or more of said resin beads by count comprise void spaces no greater than 5 microns.

35. An improved process for making a T-20 or T-1249 polypeptide composition, optionally using linkers covalently bound to resin beads, in which said improvement comprises:
using a plurality of resin beads functionalized using a nitro-containing compound to make one or more fragments of said polypeptide composition, said resin beads being optionally loaded with an amino acid or amino acid derivative; assembling said one or more fragments to make said polypeptide composition; and optionally recycling said plurality of resin beads.

36. The process of claim 35 in which nitro-containing compound is a C1-C6 nitroalkane or a nitro-aryl.

37. The process of claim 36 in which said nitro-containing compound is selected from the group consisting of nitro-benzene or nitro-toluene.

38. A T-20 or T-1249 composition, in which one or more fragments of T-20 or T-1249, are made by the process of claim 35.

39. An improved process for making a polypeptide composition, or a fragment of a polypeptide composition, optionally using linkers covalently bound to resin beads, in which said improvement comprises:
using a plurality of functionalized resin beads prepared using a chloride corrosion resistant filter, said resin beads being optionally loaded with an amino acid or amino acid derivative, to create one or more polypeptide fragments; and, optionally recycling said resin beads.

40. The process of claim 39 in which said chloride corrosion resistant filter comprises a nickel alloy filter.

41. The process of claim 40 in which said nickel alloy filter is a Hastalloy™ filter.

42. The process of claim 41 in which said chloride corrosion resistant filter is selected from the group consisting of a glass lined filter or a Teflon™ lined filter.

43. The process of claim 39 in which said resin beads comprise 0.5% to 1.5% DVB.

44. The process of claim 40 in which said resin beads have CTC linkers thereon.

45. The process of claim 41 in which one gram of said resin beads will swell to between four to seven cubic centimeters.

46. A T-20 or T-1249 composition, in which one or more fragments of T-20 or T-1249, are made by the process of claim 39.

47. An improved process for making a polypeptide composition, or a fragment of a polypeptide composition, optionally using linkers covalently bound to resin beads, in which said improvement comprises:
using a plurality of functionalized resin beads made from copolymer comprising less than 5% organic extractables, said resin beads being optionally loaded with an amino acid or amino acid derivative, to create one or more polypeptide fragments; and, optionally recycling said resin beads.

48. The process of claim 47 in which said resin beads are made from copolymer comprising less than 3% of organic extractables.

49. The process of claim 48 in which said resin beads are made from copolymer comprising less than 2% organic extractables.

50. The process of claim 49 in which said resin beads are made from copolymer comprising comprise less than 1% organic extractables.

51. The process of claim 1 in which said using is performed in an industrially sized vessel, said industrially sized vessel optionally having a capacity of at least 50 liters.

52. The process of claim 43 in which said using is performed in an industrially sized vessel, said industrially sized vessel having a filtering surface of at least one half square meter.

53. An improved process for making a polypeptide composition, or a fragment of a polypeptide composition, optionally using linkers covalently bound to resin beads, in which said improvement comprises:
using a plurality of free flowing resin beads to create one or more polypeptide fragments, said free flowing resin beads being prepared under agitation with a non-swelling solvent after washing thereof and before drying thereof.

54. An improved process for making a T-20 or T-1249 composition, or a fragment thereof, in which said improvement comprises:
using functionalized resin beads having a homogeneous density to create one or more polypeptide fragments.

55. The process of claim 54 in which greater than 50 percent of total beads within a batch of functionalized resin beads have a homogeneous density.
